(19) United States
(12) Patent Application Publication
(10) Pub. No.: US 2013/0047872 A1
(43) Pub. Date: Feb. 28, 2013

(54) DISC DRIVE DEVICE

(71) Applicants: Yoshitaka ONISHI, Tokyo (JP); MASAKAZU SONE, KANAGAWA (JP)

(72) Inventors: Yoshitaka ONISHI, Tokyo (JP); MASAKAZU SONE, KANAGAWA (JP)

(21) Appl. No.: 13/592,952

(22) Filed: Aug. 23, 2012

(30) Foreign Application Priority Data
Aug. 30, 2011 (JP) 2011-187928

(51) Int. Cl. B41F 17/08

(52) U.S. Cl. 101/39

(57) ABSTRACT

There is provided a disc drive device including a recording and playback unit that performs recording or playback of an information signal on a disc-shaped recording medium having a printing surface and a recording surface; a printing head that performs printing on the printing surface of the disc-shaped recording medium; a roller that is separated from or comes into contact with an outer circumferential surface of the disc-shaped recording medium and rotates the disc-shaped recording medium by being rotated while in contact with the outer circumferential surface; a spring member that biases the roller in an axial direction of the roller; and a position restricting member that has a restricting section against which the roller biased by the spring member is pressed and performs the positioning of the roller in the axial direction.

### BACKGROUND

The present technology relates to a technical field concerning a disc drive device. Specifically, the present technology relates to a technical field which prevents the occurrence of problems caused by contact defects of a roller against a disc-shaped recording medium by axially biasing a roller rotating the disc-shaped recording medium in contact with an outer circumferential surface of the disc-shaped recording medium by a spring member to perform the positioning.

Along with the advancement of digital technology in recent years, as a recording medium for perform the recording and playback of voice information and image information, various disc-shaped recording media such as a CD (Compact Disc), a DVD (Digital Versatile Disc), and a BD (Blu-ray Disc) have been propagated.

Such disc-shaped recording media include disc-shaped recording media in which there is a high demand to print the contents of the recorded information or the like on the surface thereof in addition to performing the recording and playback of voice information and image information, and one surface thereof is formed as a printing surface.

By printing the contents or the like of the recorded information on the printing surface, it is possible for a user to understand the recorded information and easily specify a desired disc-shaped recording medium, and thus an improvement in usability can be promoted.

In a disc drive device that performs the recording or playback of an information signal on the disc-shaped recording medium, a recording and playback unit that performs the recording or playback on the recording surface of the disc-shaped recording medium, and a printing unit that performs the printing on the printing surface of the disc-shaped recording medium are provided (For example, see Japanese Patent Laid-open Publication No. 2007-50514).

In the disc drive device provided with the printing unit, a disc-shaped recording medium having one surface as a printing surface and the other surface as a recording surface is mounted, the recording or playback of the information signal is performed on the recording surface by the recording and playback unit having an optical pickup, and the printing is performed on the printing surface by the printing unit having a printing head.

In order to move the optical pickup along the recording surface and perform and recording or playback of the information signal, the recording and playback unit having the optical pickup or the like is placed on a side opposite to the recording surface. Furthermore, in order to move the printing head along the printing surface and perform the printing, the printing unit having the printing head is placed on a side opposite to the printing surface.

Thus, the recording and playback unit and the printing unit are placed on the opposite sides of the disc-shaped recording medium in a thickness direction with the disc-shaped recording medium mounted on a disc table interposed therebetween.

Although there are various types of printing, when the printing unit using an ink jet print type is used in the disc drive device as mentioned above, there is a concern that an ink mist may be scattered inside the disc drive device and contaminate the disc-shaped recording medium and various parts placed inside the disc drive device.

Thus, for the type of printing that is used in the disc drive device as mentioned above, in order to avoid the contamination of various parts, a thermal transfer type such as that using a thermal head, which performs printing using heat by pressing the printing head against the printing surface, is preferred.

The disc drive device described in Japanese Patent Laid-open Publication No. 2007-50514 is configured so that a roller is rotatably supported by a rotatable lever, and the roller comes into contact with or is separated from the outer circumferential surface of the disc-shaped recording medium by the rotational movement of the lever.

When the roller is rotated in a state in which the roller is in contact with the outer circumferential surface of the disc-shaped recording medium, the disc-shaped recording medium is rotated along with the rotation of the roller.

### SUMMARY

However, in the disc drive device as mentioned above, a mechanism having the roller and the lever is constituted by a plurality of respective members such as gears other than the roller and the lever. Thus, the position of the roller is misaligned in an axial direction of the roller with respect to the disc-shaped recording medium due to machining accuracy and assembling accuracy of each component, and there is a concern that a contact failure, in which the roller does not suitably come into contact with the outer circumferential surface of the disc-shaped recording medium, may be generated.

Such a contact failure includes, for example, problems in which the roller rides on the surface of the disc-shaped recording medium and the roller does not come into contact with the correct position of the disc-shaped recording medium.

When the roller rides on the surface of the disc-shaped recording medium, there is a risk that problems such as damage of the surface of the disc-shaped recording medium may be generated. Furthermore, when the roller does not come into contact with the correction position of the disc-shaped recording medium, the disc-shaped recording medium does not easily rotate, and there is a risk of the printing detects in which the printing overlaps each other in the same location.

Furthermore, in a so-called vertical type disc drive device in which the disc-shaped recording medium is rotated in a horizontally oriented state, the position of the roller is shifted with respect to the disc-shaped recording medium due to gravity, and there is a risk of the contact defects of the roller to the disc-shaped recording medium.

Thus, an object of the present technology is to overcome the problems mentioned above and prevent the occurrence of the problems due to the contact failure of the roller to the disc-shaped recording medium.

According to a first embodiment of the present technology, there is provided a disc drive device including a recording and playback unit that performs recording or playback of an information signal on a disc-shaped recording medium having a printing surface and a recording surface, a printing head that performs printing on the printing surface of the disc-shaped recording medium, a roller that is separated from or comes into contact with an outer circumferential surface of the disc-shaped recording medium and rotates the disc-shaped recording medium by being rotated while in contact with the outer circumferential surface, a spring member that biases the roller in an axial direction of the roller, and a position restricting member that has a restricting section against which the roller biased by the spring member is pressed, and performs the positioning of the roller in the axial direction.

Thus, in the disc drive device, the roller comes into contact with the outer circumferential surface of the disc-shaped recording medium while positioned by the position restricting member.

According to a second embodiment of the present technology, in the disc drive device mentioned above, the roller may be rotated in a state in which one surface thereof in the axial direction is pressed against the restricting section, and the restricting section of the position restricting member may be provided with a sliding rib which protrudes to the one surface side of the roller and on which the one surface slides.

By providing the restricting section of the position restricting member with the sliding rib which protrudes to the one surface side of the roller and on which the one surface slides, a contact area of the roller to the position restricting member is reduced when the roller is moved.

According to a third embodiment of the present technology, in the disc drive device mentioned above, the recording and playback unit may have a disc table on which the disc-shaped recording medium is mounted, the recording and playback unit may be supported by a disc tray that is moved in a predetermined direction, a chassis by which the disc tray is movably supported may be provided, and the position restricting member may be attached to the chassis.

By providing the chassis by which the disc tray is movably supported and attaching the position restricting member to the chassis, high positional accuracy of the position restricting member to the disc-shaped recording medium is secured.

According to a fourth embodiment of the present technology, in the disc drive device, the position restricting member may be provided with an attachment target section attached to the chassis, and a reinforcing rib section that connects the attachment target section with the restricting section.

By providing the position restricting member with the attachment target section attached to the chassis, and the reinforcing rib section that connects the attachment target section with the restricting section, the restricting section is reinforced by the reinforcing rib section, and thus the restricting section is hardly deformed when the roller is pressed against the position restricting member.

According to a fifth embodiment of the present technology, in the disc drive device mentioned above, an actuating lever, in which the roller is rotatably supported and which is moved in a direction to be separated from or come into contact with the outer circumferential surface of the disc-shaped recording medium, may be provided, the spring member may be placed between the actuating lever and the roller, the actuating lever may be formed with a recessed section for placement opened to the roller side, and at least a part of the spring member may be placed in the recessed section for placement.

By placing the spring member between the actuating lever and the roller, forming the recessed section for placement opened to the roller side in the actuating lever, and placing at least a part of the spring member in the recessed section for placement, a length from one end surface of the actuating lever to one end of the spring member is shortened.

According to a sixth embodiment of the present technology, in the disc drive device mentioned above, the roller may be formed with a recessed section opened to the actuating lever side, and at least a part of the spring member may be placed in the recessed section.

By forming the recessed section opened to the actuating lever side in the roller, and placing at least a part of the spring member in the recessed section, the length from the other end of the spring member to one end of the roller is shortened.

According to a seventh embodiment of the present technology, in the disc drive device mentioned above, a coil spring may be used as the spring member, and a center axis serving as a rotation center of the roller may be located inside the spring member.

By positioning the center axis of the rotation center of the roller inside the spring member using the coil spring as the spring member, a placement space of the center axis and the spring member is reduced.

According to an eighth embodiment of the present technology, in the disc drive device mentioned above, the roller may be provided with a pair of flange sections positioned so as to be separated from each other in the axial direction, and a contact drive section which is positioned between the pair of flange sections, is in contact with the outer circumferential surface of the disc-shaped recording medium and has an outer diameter smaller than those of the flange sections, and the surfaces opposite to each other on outer circumferential sections of the pair of flange sections may be formed with guidance surfaces which separate from each other toward an outer circumference.

By forming the guidance surfaces that separate from each other toward the outer circumference on the surfaces opposite to each other in the outer circumferential sections of the pair of flange sections, when the roller approaches the outer circumferential surfaces of the disc-shaped recording medium, the disc-shaped recording medium can be guided by the guidance surfaces, and the disc-shaped recording medium is easily inserted between the pair of flange sections.

According to the embodiments of the present technology described above, the disc drive device of the present technology includes a recording and playback unit that performs the recording or playback of an information signal on a disc-shaped recording medium having a printing surface and a recording surface, a printing head that performs printing on the printing surface of the disc-shaped recording medium, a roller that is separated from or comes into contact with an outer circumferential surface of the disc-shaped recording medium and rotates the disc-shaped recording medium by being rotated while in contact with the outer circumferential surface, a spring member that biases the roller in an axial direction of the roller, and a position restricting member that has a restricting section against which the roller biased by the spring member is pressed, and performs the positioning of the roller in the axial direction.

Thus, the position accuracy of the roller in the axial direction is enhanced, the roller reliably comes into contact with the correct position of the outer circumferential surface of the disc-shaped recording medium, the contact failure of the roller to the disc-shaped recording medium is not generated, and it is possible to prevent the occurrence of the problems due to the contact failure of the roller to the disc-shaped recording medium.

According to the second embodiment of the present technology, the roller is rotated in a state in which one surface thereof in the axial direction is pressed against the restricting section, and the restricting section of the position restricting member is provided with a sliding rib which protrudes to the one surface side of the roller and on which the one surface slides.

Thus, since the flange section slides on the sliding rib, a contact area of the roller to the position restricting member is reduced when the roller is moved, and the load to the movement of the roller is small, whereby the roller can be smoothly moved.

According to the third embodiment of the present technology, the recording and playback unit has a disc table on which the disc-shaped recording medium is mounted, the recording and playback unit is supported by a disc tray that is moved in a predetermined direction, a chassis, on which the disc tray is movably supported, is provided, and the position restricting member is attached to the chassis.

Thus, the positional accuracy of the position restricting member to the disc-shaped recording medium is high, and thus it is possible to secure satisfactory positional accuracy of the roller and the disc-shaped recording medium pressed against the position restricting member.

According to the fourth embodiment of the present technology, the position restricting member is provided with an attachment target section attached to the chassis, and a reinforcing rib section that connects the attachment target section with the restricting section.

Thus, the restricting section is reinforced by the reinforcing rib section, and the restricting section is hardly deformed even when the roller is pressed against the position restricting member, and it is therefore possible to secure satisfactory positional accuracy of the roller in the axial direction.

According to the fifth embodiment of the present technology, an actuating lever, in which the roller is rotatably supported and which is moved in a direction to be separated from or come into contact with the outer circumferential surface of the disc-shaped recording medium, is provided, the spring member is placed between the actuating lever and the roller, the actuating lever is formed with a recessed section for placement opened to the roller side, and at least a part of the spring member is placed in the recessed section for placement.

Thus, it is possible to shorten a length from one end surface of the actuating lever to one end of the spring member, and thus thinning and miniaturization of the disc drive device can be accomplished.

According to the sixth embodiment of the present technology, the roller is formed with a recessed section opened to the actuating lever side, and at least a part of the spring member is placed in the recessed section.

Thus it is possible to shorten the length from the other end of the spring member to one end of the roller, and thus further thinning and miniaturization of the disc drive device can be accomplished.

According to the seventh embodiment of the present technology, in the disc drive device mentioned above, a center axis serving as a rotation center of the roller is positioned inside the spring member using a coil spring as the spring member.

Thus, an effective use of a placement space of the center axis and the spring member is accomplished, and accordingly, miniaturization of the disc drive device can be accomplished.

According to the eighth embodiment of the present technology, the roller is provided with a pair of flange sections positioned so as to be separated from each other in the axial direction, and a contact drive section which is positioned between the pair of flange sections, is in contact with the outer circumferential surface of the disc-shaped recording medium and has an outer diameter smaller than those of the flange sections, and the surfaces opposite to each other on the outer circumferential sections of the pair of flange sections are formed with guidance surfaces which separate from each other toward the outer circumference.

Thus, when the roller approaches the outer circumferential surface of the disc-shaped recording medium, the disc-shaped recording medium can be guided by the guidance surfaces, and the disc-shaped recording medium is easily inserted between the pair of flange sections, and it is therefore possible to reliably bring the contract drive section of the roller into contact with the outer circumferential surface of the disc-shaped recording medium.

### BRIEF DESCRIPTION OF THE DRAWINGS

FIG. 1 is a perspective view of a disc drive device that shows an embodiment of the disc drive device of the present technology together with FIGS. 2 to 31;

FIG. 2 is a perspective view that shows the disc drive device together with a recording medium in a state in which a disc tray is opened;

FIG. 3 is a schematic plan view that shows an internal structure of the disc drive device with a part thereof in a cross-section;

FIG. 4 is an exploded perspective view of a printing unit or the like;

FIG. 5 is a perspective view of the printing unit;

FIG. 6 is a plan view of the printing unit;

FIG. 7 is a front view of the printing unit;

FIG. 8 is a side view of the printing unit;

FIG. 9 is a rear view that shows a support base along with each member attached thereto;

FIG. 10 is an enlarged and exploded perspective view that shows an actuating lever and each section supported by the actuating lever;

FIG. 11 is an enlarged cross-sectional view that shows the actuating lever, and each section supported by the actuating lever;

FIG. 12 is a perspective view that shows a feeding base, a cam support lever, a head holding lever, and each member supported thereby;

FIG. 13 is a plan view that shows an operation of the printing unit together with FIGS. 14 to 31, and shows an initial state;

FIG. 14 is a front view that shows the initial state;

FIG. 15 is a side view that shows the initial state;

FIG. 16 is a plan view that shows a state immediately after the movement of a head feeding section is initiated from the initial state toward a folding position;

FIG. 17 is an enlarged cross-sectional view that shows a state in which the actuating lever is rotated and the roller comes into contact with an outer circumferential surface of a disc-shaped recording medium;

FIG. 18 is a front view that shows a state immediately after the movement of the head feeding section is initiated from the initial state toward the folding position;

FIG. 19 is a plan view that shows a state in which the head feeding section is moved toward the folding position subsequent to FIG. 16;

FIG. 20 is a front view that shows a state in which the head feeding section is moved toward the folding position subsequent to FIG. 18;

FIG. 21 is a schematic front view that shows a state in which the printing head is pressed against the printing surface of the disc-shaped recording medium;

FIG. 22 is a plan view that shows a state in which the head feeding section is moved up to the folding position;

FIG. 23 is a front view that shows a state in which the head feeding section is moved up to the folding position;

FIG. 24 is a side view that shows a state in which the head feeding section is moved up to the folding position;

FIG. 25 is a plan view that shows an intermediate state in which the head feeding section is moved from the folding position toward the initial position;

FIG. 26 is a front view that shows the intermediate state in which the head feeding section is moved from the folding position toward the initial position;

FIG. 27 is an enlarged plan view that shows a state in which a moving cam slides on a return cam;

FIG. 28 is a plan view that shows a state in which the head feeding section is moved up to the initial position;

FIG. 29 is a front view that shows a state in which the head feeding section is moved up to the initial position;

FIG. 30 is a plan view that shows a state in which the drive motor is rotated again and the roller is in contact with the disc-shaped recording medium; and

FIG. 31 is a plan view that shows a state in which the disc-shaped recording medium is rotated by the rotation of the roller.

### DETAILED DESCRIPTION OF THE EMBODIMENTS

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

Hereinafter, an embodiment of the disc drive device of the present technology will be described with reference to the accompanying drawings.

In the description provided below, a front and back direction, an up and down direction, and a left and right direction are shown by setting a thickness direction of the disc-shaped recording medium as the up and down direction.

Furthermore, the front and back direction, the up and down direction, and the left and right direction shown below are for the convenience of the description, and the embodiments of the present technology are not limited to such directions.

### [Configuration of Disc Drive Device]

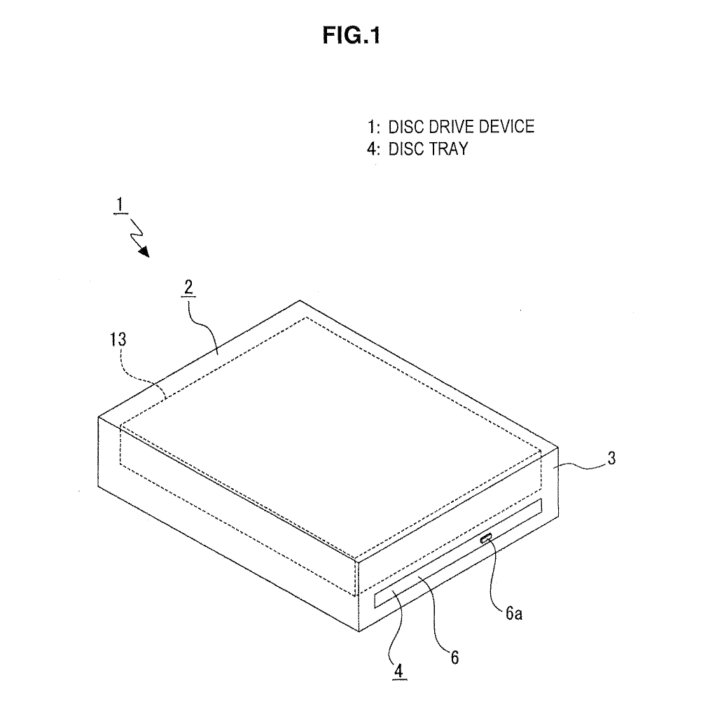

A disc drive device 1 is formed by placing the respective necessary sections inside an external housing 2 (see FIGS. 1 to 3).

The external housing 2 is formed in a flat box shape having an up and down length shorter than a front and back length and a left and right length, and a lower half section of a front section 3 has a tray insertion and removal port 3a.

The disc drive device 1 is provided with a disc tray 4, and the disc tray 4 is moved in the front and back direction and drawn from the external housing 2 via the tray insertion and removal port 3a or is housed inside the external housing 2. The disc tray 4 has a tray main body 5, and a rectangular front panel 6 attached to the front of the tray main body 5.

The tray main body 5 is formed with an upwardly opening disc loading recessed section 5a. The tray main body 5 is formed with a vertically penetrating placement hole 5b. The left and right end sections of the tray main body 5 are provided as guide target sections 5b and 5c, respectively.

The recording and playback unit 7 is placed in the placement hole 5b of the tray main body 5. The recording and playback unit 7 has a pickup base 7a, a disc table 7b attached to the pickup base 7a, and an optical pickup 7c movably supported on the pickup base 7a.

The recording and playback unit 7 can be moved in the up and down direction. The disc table 7b is rotated by a spindle motor (not shown). In a state in which the recording and playback unit 7 is positioned in a lower moving end, the disc table 7b is positioned below the disc loading recessed section 5a, and in a state in which the recording and playback unit 7 is positioned in an upper moving end, the disc table 7b is positioned above the disc loading recessed section 5a.

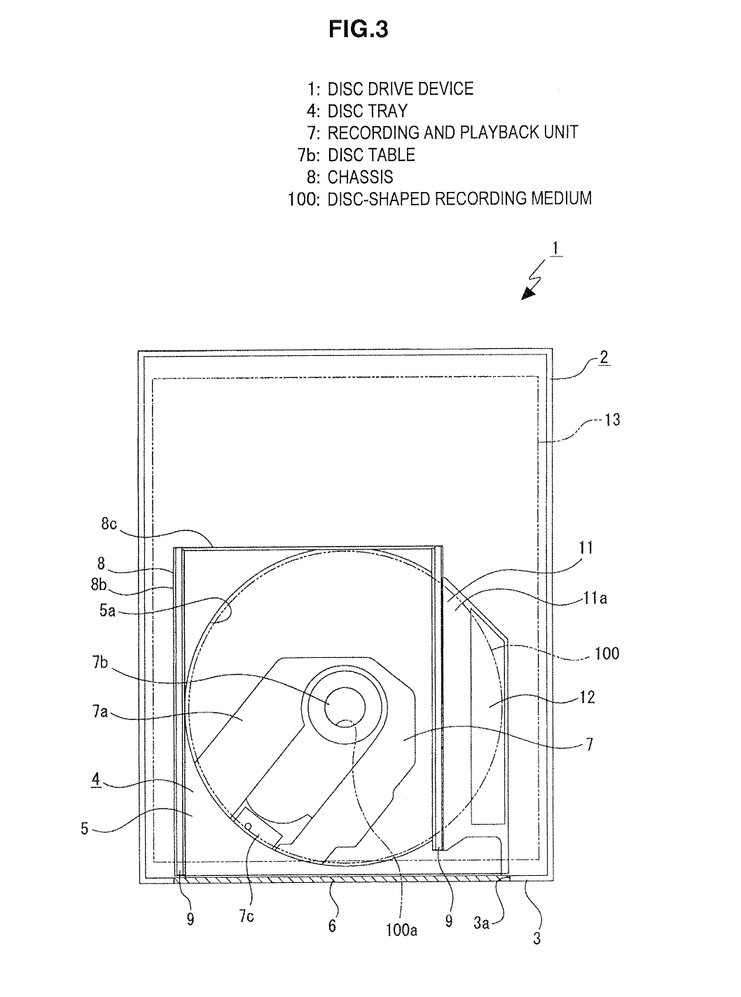

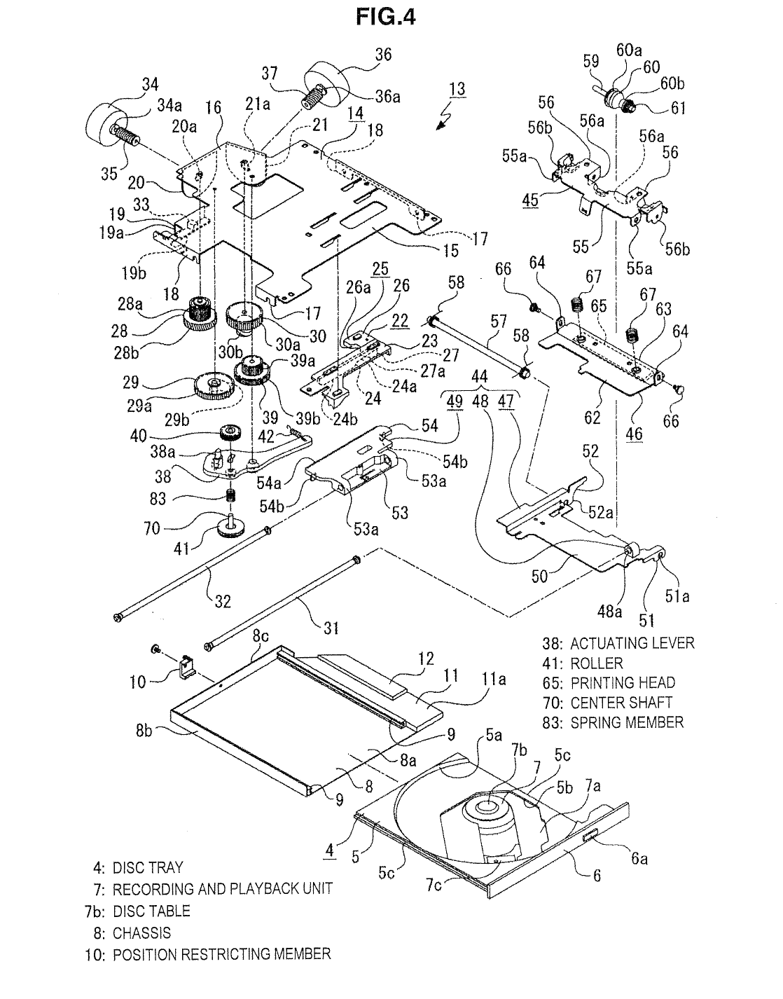

A chassis 8 is placed inside the external housing 2 (see FIGS. 3 and 4). The chassis 8 has a bottom surface section 8a, a side surface section 8b protruding upward from a side edge of the bottom surface section 8a, and a back surface section 8c protruding upward from a back edge of the bottom surface section 8a.

Guide rails 9 and 9 are attached to left and right end sections of the chassis 8, respectively. The guide target sections 5c and 5c of the disc tray 4 are each supported by the guide rails 9 and 9 in a freely sliding manner, and the disc tray 4 is guided by the guide rails 9 and 9 and is moved in the front and back direction.

A position restricting member 10 is attached to a rear surface section 8c of the chassis 8. The details of the position restricting member 10 will be described later.

A right end section of the front panel 6 is positioned in a right side from the tray main body 5. An operation button 6a is placed in the front panel 6. When the operation button 6a is operated in a state in which the disc tray 4 is housed inside the external housing 2, the disc tray 4 is moved forward and is drawn from the external housing 2, thus enabling a disc-shaped recording medium 100 to be loaded in the disc loading recessed section 5a of the tray main body 5. In a state in which the disc-shaped recording medium 100 is loaded in the disc loading recessed section 5a of the tray main body 5, a part (the right end section) of the disc-shaped recording medium 100 protrudes from the tray main body 5 to the right side.

When the operation button 6a is operated in a state in which the disc-shaped recording medium 100 is loaded in the disc loading recessed section 5a of the tray main body 5 drawn from the external housing 2, the disc tray 4 is moved backward and is housed inside the external housing 2. When the disc tray 4 is housed inside the external housing 2, the recording and playback unit 7 rises, the disc table 7b is inserted from the lower section into the center hole 100a of the disc-shaped recording medium 100, and the disc-shaped recording medium 100 is mounted on the disc table 7b.

In a state in which the disc-shaped recording medium 100 is mounted on the disc table 7b, the disc-shaped recording medium 100 is positioned so as to be separated upward from the tray main body 5.

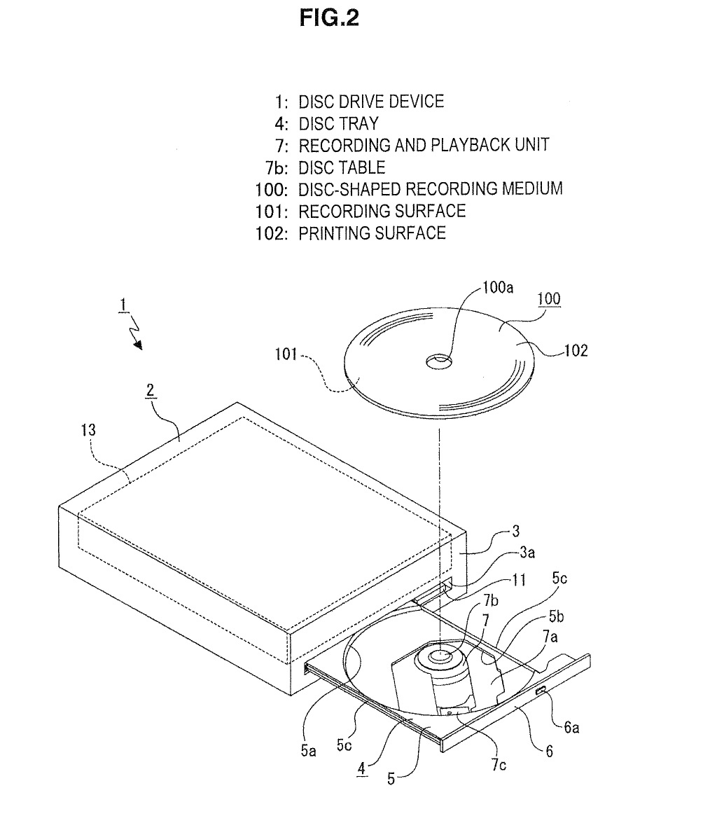

The disc-shaped recording medium 100 is configured so that a lower surface thereof is formed as a recording surface on which an information signal is recorded, and an upper surface thereof is formed as a printing surface 102 on which printing is performed (see FIG. 2). The printing surface 102 is formed, for example, by gluing a thermal paper to the surface of the disc-shaped recording medium 100 or applying paint that can be printed by a printing head (a thermal head).

When the operation button 6a is operated in a state in which the disc-shaped recording medium 100 is mounted on the disc table 7b, the recording and playback head 7 is lowered, and the disc table 7b is moved to the bottom of the disc loading recessed section 5a. At this time, the disc-shaped recording medium 100 is placed in the disc loading recessed section 5a, thus releasing the mounting of the disc-shaped recording medium 100 to the disc table 7b. Next, the disc tray 4 is moved forward and drawn from the external housing 2, thus enabling the disc-shaped recording medium 100 to be removed from the disc loading recessed section 5a.

Furthermore, although an example in which the recording and playback unit 7 is moved in the up and down direction to mount and release the disc-shaped recording medium 100 on and from the disc table 7b has been described, for example, the recording and playback unit 7 may have a configuration which is not moved in the up and down direction. In this case, the disc table protrudes upward from the disc tray in advance, and a user can perform the mounting and releasing of the disc-shaped recording medium on and from the disc table in a state in which the disc tray is drawn from the external housing.

A placing base 11 is placed in a right end section in the interior of the external housing 2 (see FIGS. 3 and 4). The placing base 11 is continuously provided in the right end section of the chassis 8.

The placing base 11 is formed in an elongated shape from front to back. An upper surface of the placing base 11 is formed as a base surface 11a. A cushion member 12, for example, formed of a rubber material, a felt material or the like is attached to a part of the base surface 11a.

A printing unit 13 is placed above the recording and playback unit 7 in the external housing 2 (see FIGS. 2 and 3).

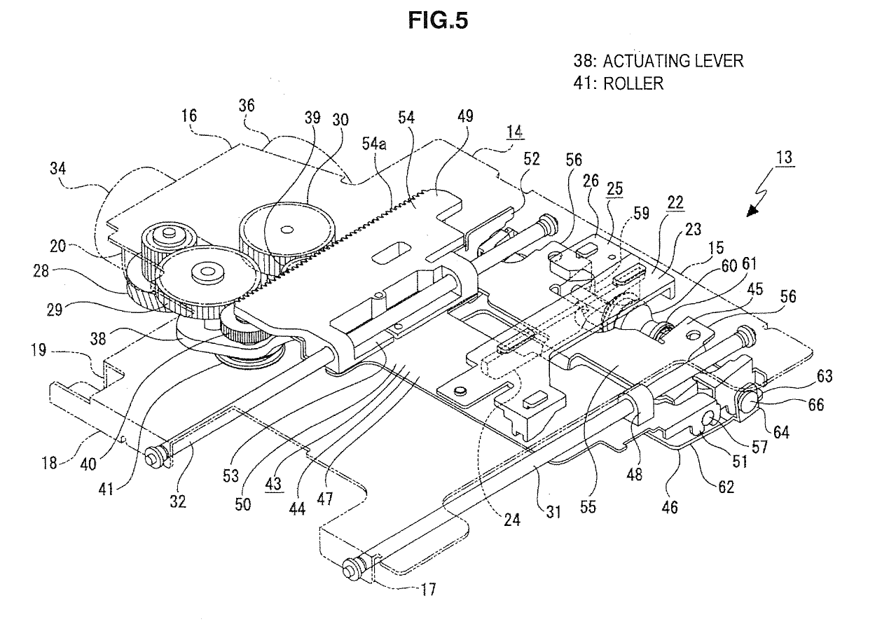

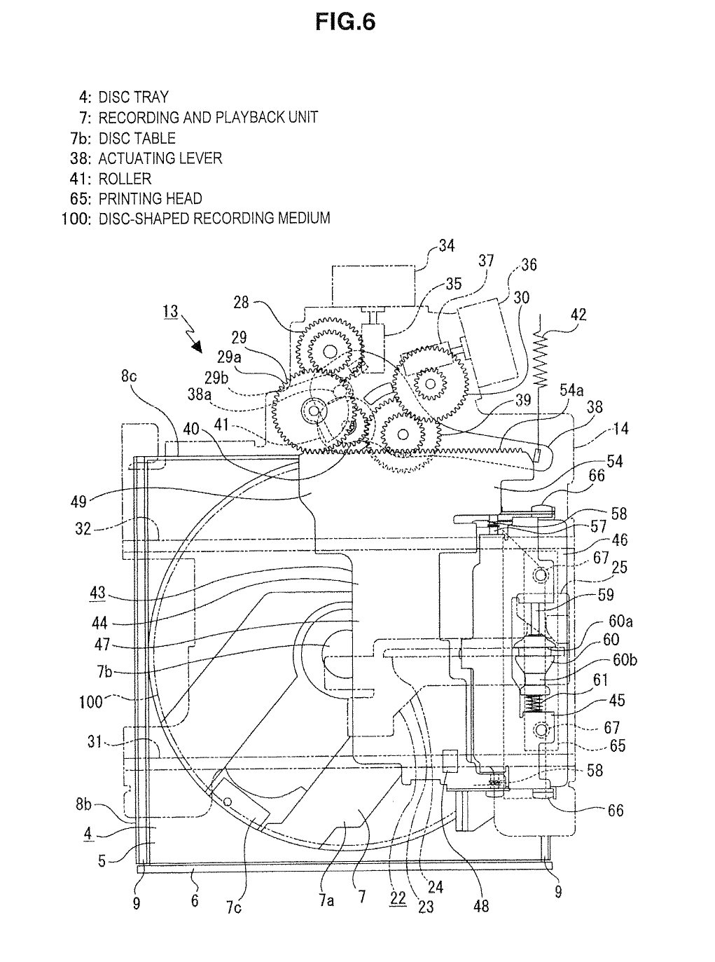

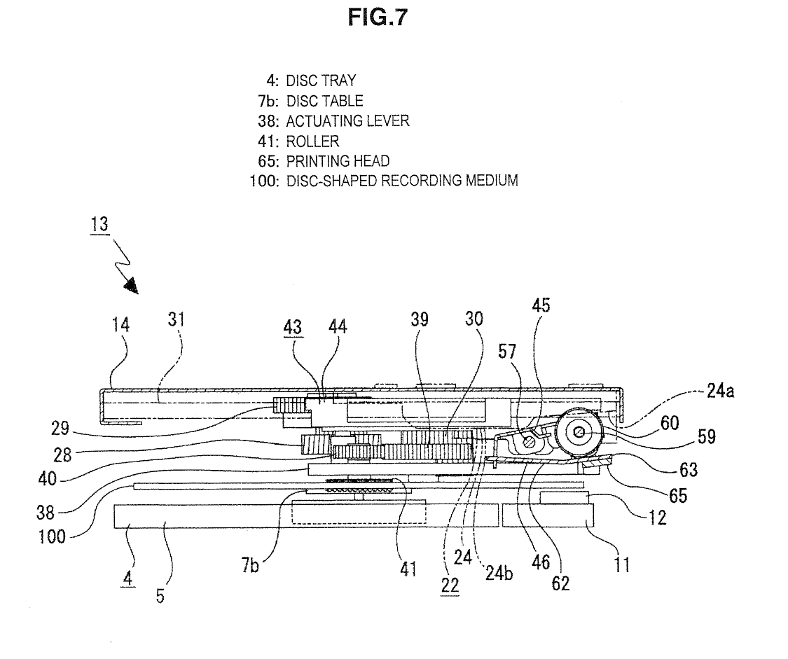

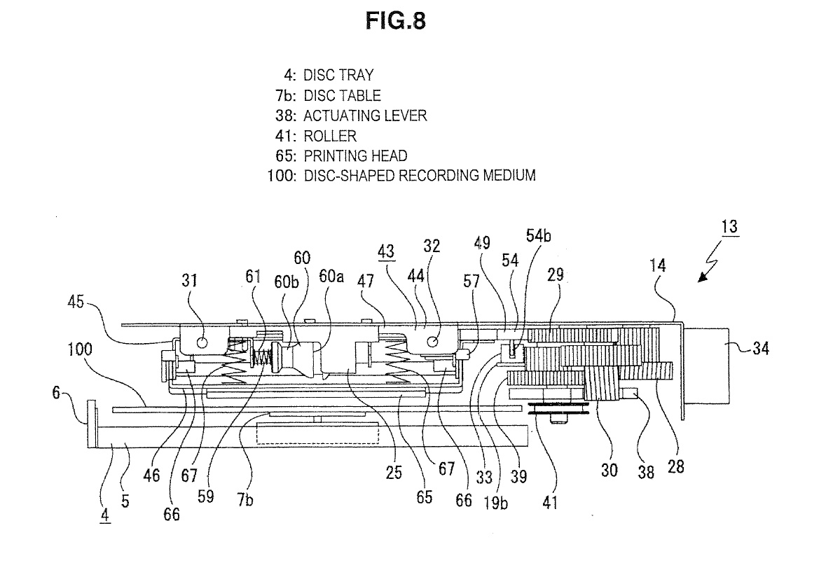

The printing unit 13 is formed by supporting or attaching the necessary member to the support base 14 (see FIGS. 4 to 8).

The support base 14 is fixed to the upper end side in the interior of the external housing 2.

The support base 14 has a base section 15 oriented in the up and down direction, a gear support section 16 protruding backward from the base section 15, shaft attachment sections 17, 17, 18 and 18 each protruding downward from the base section 15, a sensor attachment section 19 protruding downward from the base section 15, and motor attachment sections 20 and 21 each protruding downward from the gear support section 16.

The gear support section 16 protrudes backward from the center section of the base section 15 in the left and right direction.

The shaft attachment sections 17 and 17 protrude downward from a position near the front end in the left and right edges of the base section 15, respectively, and the shaft attachment sections 18 and 18 protrude downward from a position near a rear end in the left and right edges of the base section 15, respectively.

The sensor attachment section 19 includes a connection surface section 19a protruding downward from the position near the left end in the rear edge of the base section 15, and an attachment surface section 19b protruding forward from the lower edge of the connection surface section 19a.

The motor attachment section 20 protrudes downward from the rear edge of the gear support section 16, and the motor attachment section 21 protrudes downward from the right side edge of the gear support section 16. The motor attachment sections 20 and 21 are formed with insertion holes 20a and 21a, respectively.

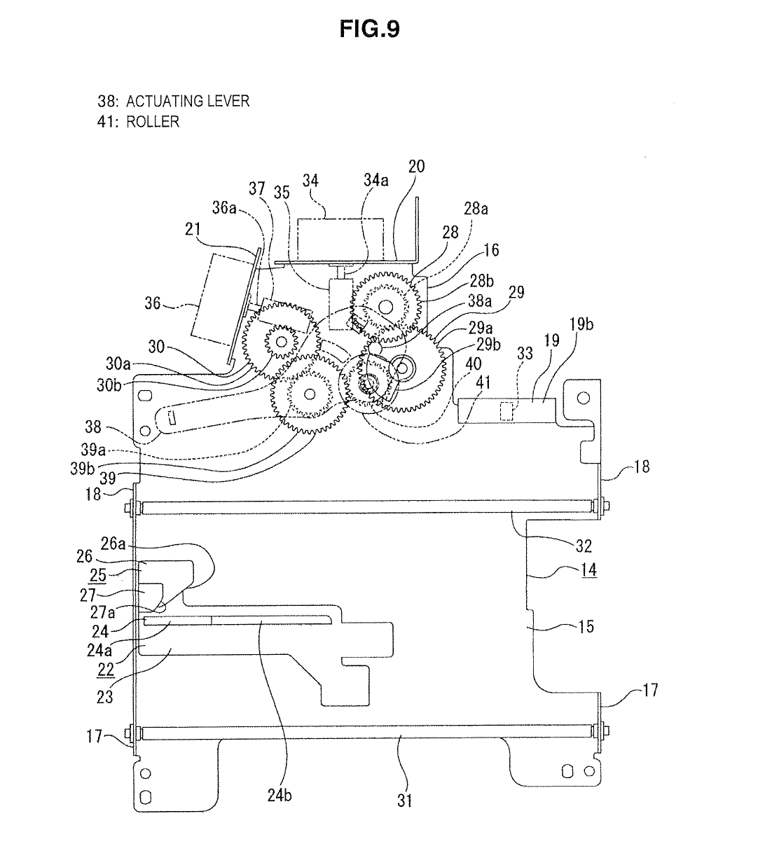

A guidance cam 22 is attached to the right end side of the lower surface of the base section 15 of the support base 14 (see FIG. 9). The guidance cam 22 includes an attachment target surface section 23 which is formed in a shape extended from side to side and is formed in a plate shape oriented in the up and down direction, and a cam guide section 24 which protrudes downward from the attachment target surface section 23 and is formed in a plate shape oriented in the front and back direction. The cam guide section 24 extends from side to side, the right end section of the cam guide section 24 is provided as a first action section 24a, and the cam guide section 24 includes the first action section 24a and a second action section 24b connected to the left end of the first action section 24a. The second action section 24b has an amount of downward projection greater than that of the first action section 24a, and the first action section 24a is formed so that the amount of downward projection increases toward the second action section 24b.

A return cam 25 is attached to the immediate rear side of the guidance cam 22 in the right end section on the lower surface of the base section 15. The return cam 25 includes an upper guidance section 26 and a lower guidance section 27, and the upper guidance section 26 and the lower guidance section 27 are respectively formed with guidance surfaces 26a and 27a tilted so as to be displaced forward toward the right side.

A transmission gear 28, a feeding gear 29, and a stepped gear 30 are rotatably supported by the gear support section 16 of the support base 14.

The transmission gear 28 and the feeding gear 29 are sequentially positioned from the rear side in the left end section of the gear support section 16 and are positioned on the lower surface side of the gear support section 16. The transmission gear 28 includes a small-diameter section 28a and a large-diameter section 28b. The feeding gear 29 includes a gear section 29a and an action section 29b provided on the lower surface of the gear section 29a, and the action section 29b is provided in a portion over the outer circumferential section from the center section of the gear section 29a and protruding downward from the gear section 29a. The small-diameter section 28a of the transmission gear 28 is meshed with the gear section 29a of the feeding gear 29.

The stepped gear 30 is positioned on the lower surface side in the right end section of the gear support section 16, and includes a large-diameter section 30a and a small-diameter section 30b.

Guide shafts 31 and 32 each functioning as guide members are attached between the shaft attachment sections 17 and 17 and the shaft attachment sections 18 and 18 of the support base 14, respectively (see FIGS. 4 to 8). The guide shafts 31 and 32 are placed so as to extend from side to side in a parallel state.

The position detection sensor 33 is attached to the attachment surface section 19b of the sensor attachment section 19 in the support base 14.

A drive motor 34 is attached to a rear surface of the motor attachment section 20 of the support base 14. A worm 35 is fixed to a motor shaft 34a of the drive motor 34. The worm 35 is inserted through the insertion hole 20a, is positioned in front of the motor attachment section 20, and is meshed with the large-diameter section 28b of the transmission gear 28.

A rotating motor 36 is attached to a right side of the motor attachment section 21 of the support base 14. A worm 37 is fixed to the motor shaft 36a of the rotating motor 36. The worm 37 is inserted through the insertion hole 21a, is positioned on the left side of the motor attachment section 21, and is meshed with the small-diameter section 30b of the stepped gear 30.

An actuating lever 38 is rotatably supported by a rear end section of the base section 15 of the support base 14. The actuating lever 38 is formed in a shape substantially extended from side to side, and a substantially central section thereof in the left and right direction is a rotation fulcrum. An action target protrusion section 38a protruding upward is provided in a position near the left end of the actuating lever 38, and the action target protrusion section 38a can be meshed with the restricting section 29b of the transmission gear 29.

A middle gear 39 is rotatably supported by the rotation fulcrum of the actuating lever 38. The middle gear 39 includes a small-diameter section 39a and a large-diameter section 39b. The middle gear 39 is configured so that the small-diameter section 39a is meshed with the large-diameter section 30a of the stepped gear 30.

In the actuating lever 38, a driven gear 40 and a roller 41 are rotatably supported on the same axis on the left side of the middle gear 39, and the driven gear 40 and the roller 41 are integrally rotated. The driven gear 40 is positioned on the upper surface side of the actuating lever 38, and the roller 41 is positioned on the lower surface side of the actuating lever 38. The driven gear 40 is meshed with the large-diameter section 39b of the middle gear 39.

Thus, when the rotating motor 36 is rotated, the driving force thereof is sequentially transmitted to the worm 37, the stepped gear 30, and the middle gear 39, and the driven gear 40 and the roller 41 are integrally rotated.

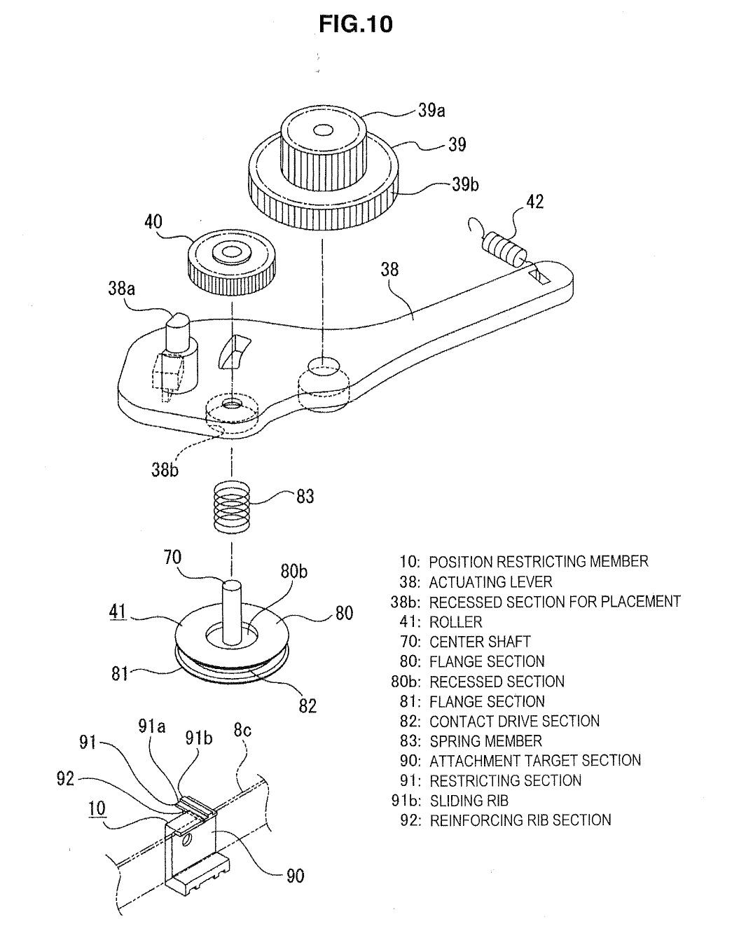

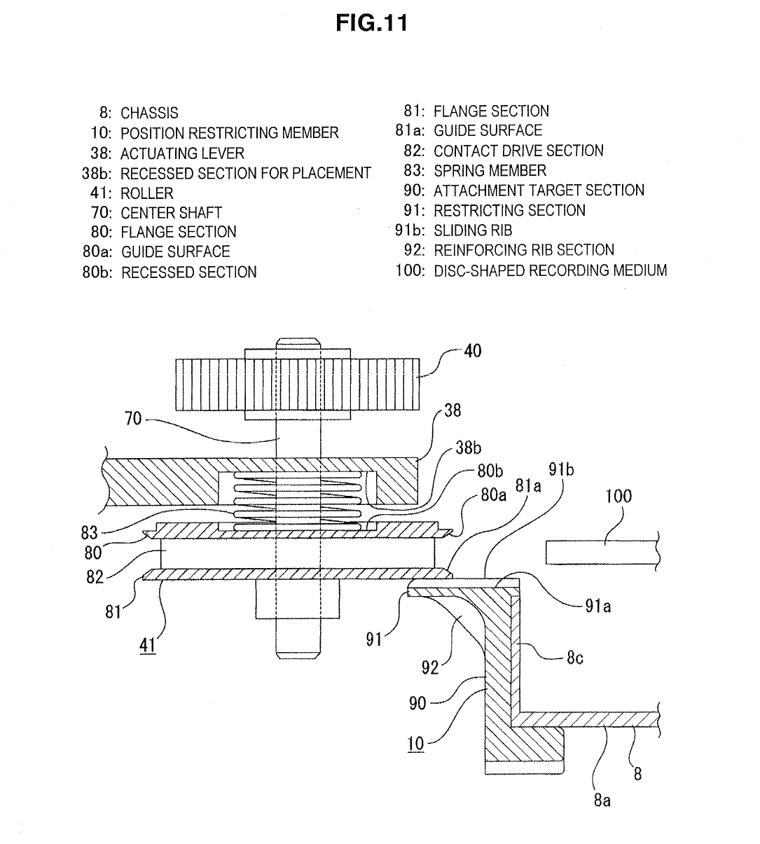

The driven gear 40 and the roller 41 are connected to each other by a center shaft 70 extended up and down (see FIGS. 10 and 11). The center shaft 70 is configured so that an upper end section thereof is fixed to the center section of the driven gear 40 and a lower end section thereof is fixed to the center section of the roller 41.

The center shaft 70 is axially and rotatably supported by the actuating lever 38. Thus, the driven gear 40 and the roller 41 are integrated with the actuating lever 38 and are able to be moved in the up and down direction.

A portion of the actuating lever 38, by which the roller 41 is supported, is formed with a downwardly opening recessed section 38b for placement.

The actuating lever 38 is biased in a rotation direction in which the left side section thereof is substantially moved forward and the right end section is substantially moved backward by a tensile coil spring 42 supported between the right end section thereof and a spring attachment section (not shown).

The roller 41 has a pair of flange sections 80 and 81 positioned so as to be vertically separated, and a contact drive section 82 positioned between the flange sections 80 and 81.

For example, the flange sections 80 and 81 are formed of a resin material such as polyoxymethylene (POM) with good slippage. On the surfaces opposite to each other on the outer circumferential surfaces of the flange sections 80 and 81, guidance surfaces 80a and 81a, which are separated from each other as they approach the outer circumference, are formed.

In the center section of the flange section 80 positioned on the upper side, an upwardly opening recessed section 80b is formed.

The contact drive section 82 is formed, for example, of a material with high adhesion such as a urethane rubber, and an outer diameter thereof is smaller than those of the flange sections 80 and 81.

A spring member 83 is placed between the actuating lever 38 and the roller 41. The spring member 83 is, for example, a compression coil spring, and the roller 41 is biased downward against the actuating lever 38 by the spring member 83. The roller 41 is connected to the driven gear 40 by the center shaft 70, and the driven gear 40 is also biased downward against the actuating lever 38 together with the roller 41.

Furthermore, the spring member 83 is not limited to the compression coil spring, and has anything having biasing force which biases the roller 41 downward, for example, a member having elasticity such as a leaf spring or rubber, may be adopted.

Furthermore, the spring member 83 is not limited to a configuration in which it is placed between the actuating lever 38 and the roller 41, and for example, the spring member 83 may have a configuration in which the spring member 83 is placed on the upper surface side of the actuating lever 38 and biases the roller 41 downward by pressing the center shaft 70 and the driven gear 40 downward.

The spring member 83 is configured so that a portion of an upper side thereof is inserted into the recessed section 38b for placement of the actuating lever 38, and a lower section thereof is inserted into the recessed section 80b of the flange section 80. Furthermore, the center position 70 is positioned inside the spring member 83.

In this manner, since the center shaft 70 is positioned inside the spring member 83, the effective use of the placing space of the center shaft 70 and the spring member 83 can be achieved, and accordingly, the miniaturization of the disc drive device 1 can be achieved.

Furthermore, since the center shaft 70 is positioned inside the spring member 83, the spring member 83 can be prevented from falling out of the actuating lever 38 and the roller 41 by the center shaft 70.

In addition, since the actuating lever 38 is formed with the recessed section 38b for placement for inserting and placing a part of the spring member 83, it is possible to reduce the length in the up and down direction from the upper surface of the actuating lever 38 to the lower end of the spring member 83 accordingly, and the thinning and the miniaturization of the disc drive device 1 can be achieved.

Furthermore, since the flange section 80 is formed with the recessed section 80b for inserting and placing a part of the spring member 83, it is possible to reduce the length in the up and down direction from the upper end of the spring member 83 to the lower surface of the roller 41, and the thinning and the miniaturization of the disc drive device 1 can be achieved.

The position restricting member 10 attached to the rear surface section 8c of the chassis 8 is positioned directly under the roller 41. The position restricting member 10 is configured so that an attachment target section 90 attached to the chassis 8, a restricting section 91 protruding backward from the upper end section of the attachment target section 90, and a reinforcing rib section 92 connecting the attachment target section 90 with the restricting section 91 are formed of, for example, a resin material such as polyoxymethylene with a good sliding property. The position restricting member 10 is attached to the rear surface section 8c of the chassis 8 by a screw fixing or the like.

The restricting section 91 is formed with a surface directed upward, and the surface directed upward is formed as the restricting surface 91a. On the restricting surface 91a of the restricting section 91, a sliding rib 91b, which protrudes upward and extends in a substantially front and back direction, is provided.

As mentioned above, the roller 41 is biased downward against the actuating lever 38 by the spring member 83, and is pressed against the position restricting member 10 positioned directly therebelow. The roller 41 is pressed against the sliding rib 91b provided in the restricting section 91 of the position restricting member 10, and the lower surface of the flange section 81 positioned on the lower side is in contact with the upper surface of the sliding rib 91b.

When the roller 41 is pressed against the position restricting member 10, the spring member 83 is compressed, and the roller 41 is positioned in the axial direction (the up and down direction).

The position restricting member 10 is provided with the reinforcing rib section 92 that connects the attachment target section 90 with the restricting section 91. Thus, the restricting section 91 is reinforced by the reinforcing rib section 92, and therefore the restricting section 91 is hardly deformed even when the roller 41 is pressed against the position restricting member 10. Thus, the satisfactory positional accuracy of the roller 41 in the axial direction can be secured.

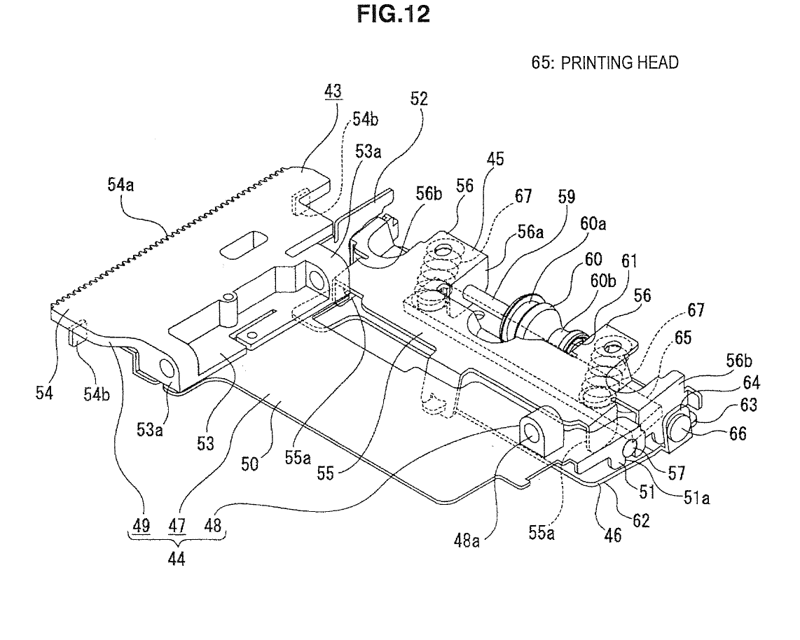

The head feeding section 43 is slidably supported by the guide shafts 31 and 32. As shown in FIGS. 4 to 12, the head feeding section 43 has a feeding base 44, a cam support lever 45 rotatably supported by the feeding base 44, and a head holding lever 46 rotatably supported by the cam support lever 45.

The feeding base 44 includes a base plate 47, a bearing member 48 attached to a front end section of the base plate 47, and a coupling member 49 attached to the rear end section of the base plate 47.

The base plate 47 has a base surface section 50 directed in the up and down direction, and side surface sections 51 and 52 each protruding upward from the front and back edges of the base surface section 50. In a position near the right ends of the side surface sections 51 and 52, support members 51a and 52a are provided, respectively.

The bearing member 48 has a bearing section 48a attached to the front end section on the upper surface of the base surface section 50.

The coupling member 49 includes an attachment target section 53 extended from side to side, and a rack section 54 protruding backward from the upper end section of the attachment target section 53. The attachment target section 53 is provided with bearing sections 53a and 53a on the left and right end sections thereof. The rear end section of the rack section 54 is formed as the rack 54a. On the lower surface in the rear end surface of the rack section 54, downwardly protruding detecting protrusion sections 54b and 54b are provided, and the detecting protrusion sections 54b and 54b are provided in the left and right end sections.

The cam support lever 45 has a base plate section 55 directed in the up and down direction, and protrusion plate sections 56 and 56 protruding from the front and back end sections of the base plate section 55 to the right side.

In the front and back end sections of the base plate section 55, support target piece sections 55a and 55a each protruding downward are provided.

The protrusion plate sections 56 and 56 are provided with cam support piece sections 56a and 56a each protruding downward in inner edges thereof, and support piece sections 56b and 56b protruding downward in outer edges thereof. The support piece sections 56b and 56b are located outside the support target piece sections 55a and 55a, respectively.

The cam support lever 45 is rotatably supported by the feeding base 44. A rotating support shaft 57 extending from front to back is attached between the support sections 51a and 51a of the feeding base 44, the rotating support shaft 57 is inserted into the support target piece sections 55a and 55a, and the cam support lever 45 is supported by the feeding base 44. Thus, the cam support lever 45 can be rotated with respect to the feeding base 44 using the rotating support shaft 57 as a fulcrum.

Rotational biasing springs 58 and 58 are supported on the front and back end sections of the rotating support shaft 57, and for example, a torsion coil spring is used as the rotational biasing springs 58 and 58. The cam support lever 45 is biased in a rotational direction in which the protrusion plate sections 56 and 56 are substantially moved upward by the rotational biasing springs 58 and 58.

A cam support shaft 59 extending from front to back is attached between the cam support piece sections 56a and 56a of the protrusion plate sections 56 and 56, and a moving cam 60 is supported by the cam support shaft 59 rotatably in the axial rotation direction and movably in the axial direction.

The moving cam 60 has an outbound cam engagement section 60a formed in a groove shape extending in a circumferential direction, and an inbound cam engagement section 60b formed in a groove shape extending in a circumferential direction and having a diameter smaller than that of the outbound cam engagement section 60a. The outbound cam engagement section 60a and the inbound cam engagement section 60b are located so as to be separated from each other in the front and back direction. As mentioned above, since the cam support lever 45 is biased in the rotational direction in which the protrusion plate sections 56 and 56 are substantially moved upward by the rotational biasing springs 58 and 58, the moving cam 60 located between the cam support piece sections 56a and 56a is substantially biased upward by the rotational biasing springs 58 and 58.

The biasing spring 61 is supported on the front side of the moving cam 60 in the cam support shaft 59. For example, a compression coil spring is used as the biasing spring 61. The moving cam 60 is biased backward by the biasing spring 61.

The head holding lever 46 has a base section 62 directed in the up and down direction, a head attachment section 63 protruding slightly upward and obliquely to the right from the right side edge of the base section 62, and support target sections 64 and 64 each protruding upward from the front and back edges of the head attachment section 63. A printing head 65 is attached to the lower surface of the head attachment section 63. For example, a thermal head is used as the printing head 65.

The head holding lever 46 is rotatably supported by the cam support lever 45. The fulcrum shafts 66 and 66 each extending from front to back are attached to the support piece sections 56b and 56b of the cam support lever 45, the fulcrum shafts 66 and 66 are inserted to the support target sections 64 and 64, and the holding lever 46 is supported by the cam support lever 45. Thus, the head holding lever 46 is able to be rotated with respect to the cam support lever 45 using the fulcrum shafts 66 and 66 as the fulcrum.

Pressing springs 67 and 67 are supported between the protrusion plate sections 56 and 56 of the cam support lever 45 and the head attachment section 63 of the head holding lever 46 so as to be separated from each other in the front and back direction. For example, a compression coil spring is used as the compressing springs 67 and 67. The head holding lever 46 is biased in the rotational direction in which the head attachment section 63 is substantially moved downward by the compressing springs 67 and 67, and is biased in a direction in which the printing head 65 attached to the head attachment section 63 is substantially moved downward.

The head feeding section 43 is configured so that the bearing section 48a of the bearing member 48 and the bearing sections 53a and 53a of the coupling member 49 are slidably supported by the guide shafts 31 and 32, respectively, are guided to the guide shafts 31 and 32 and are able to be moved in the left and right direction.

The rack 54a of the coupling member 49 is meshed with the gear section 29a of the feeding gear 29 supported by the support base 14. Thus, when the drive motor 34 is rotated, driving force thereof is sequentially transmitted to the worm 35, the transmission gear 28, the feeding gear 29, and the coupling member 49, and the head feeding section 43 is guided to the guide shafts 31 and 32 and is moved in the left and right direction.

The head feeding section 43 is reciprocated between an initial position which is a movement end of the right side and a folding position which is a movement end of the left side by driving force of the drive motor 34. At this time, the printing head 65 is reciprocated between a first position which is a movement end of the right side and a second position which is a movement end of the left side.

### [Printing Operation of Printing Unit]

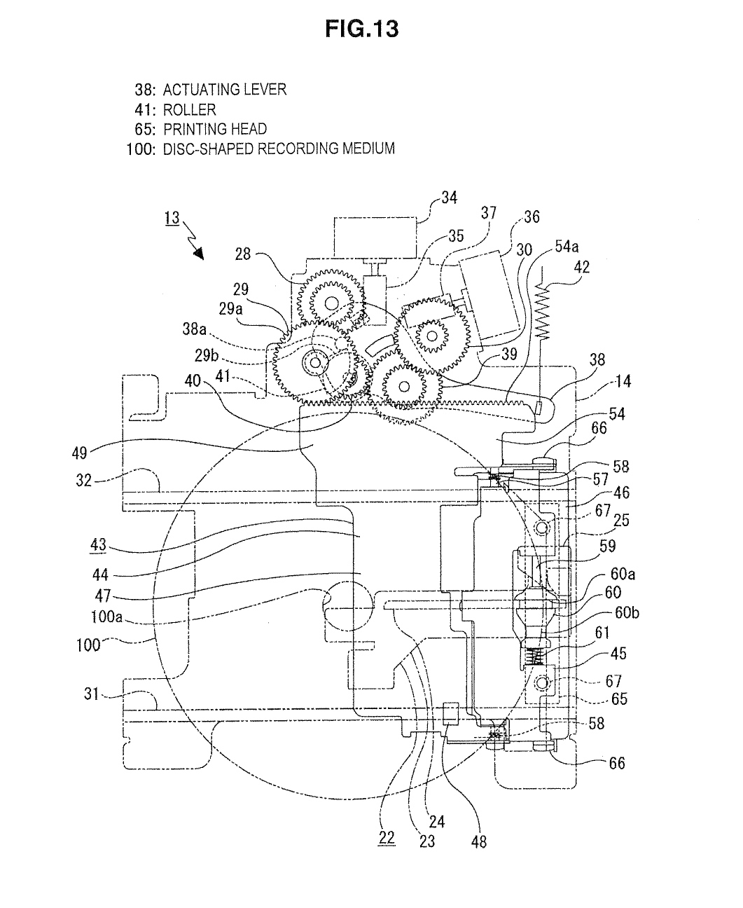

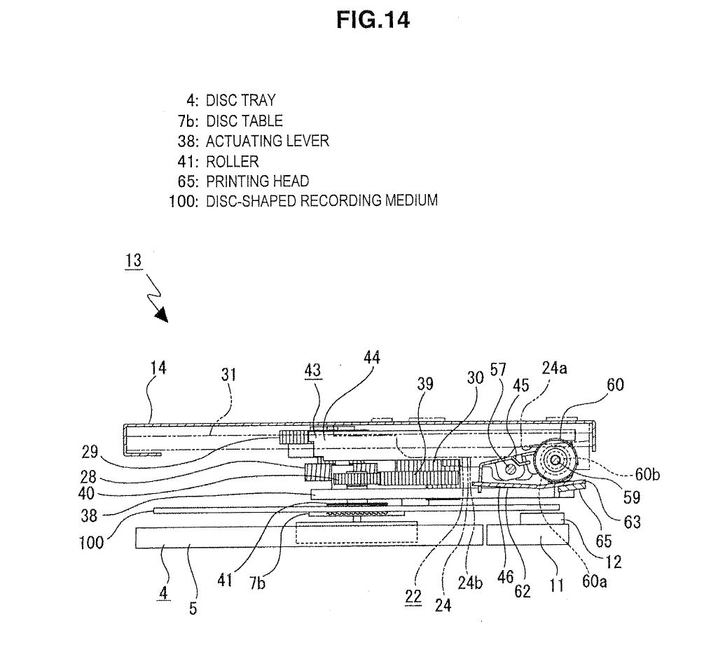

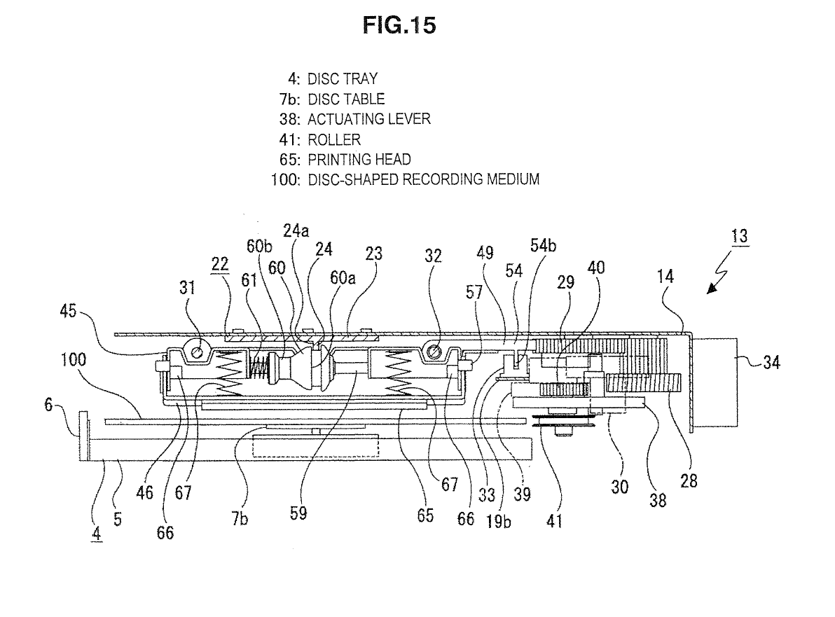

Hereinafter, a printing operation of the printing unit 13 will be described (see FIGS. 13 to 31).

Firstly, an initial state (a home position) of the printing unit 13 before performing the printing operation will be described (see FIGS. 13 to 15).

In the initial state, the feeding gear 29 is held in a predetermined position, the action section 29b is engaged with the action target protrusion section 38a of the actuating lever 38 from the front, and the actuating lever 38 is held on one rotation end against the biasing force of the tensile coil spring 42. At this time, the roller 41 supported by the actuating lever 38 is separated backward from the outer circumferential surface of the disc-shaped recording medium 100 and is held in a non-contact position where it does not come into contact with the outer circumferential surface of the disc-shaped recording medium 100. In the non-contact position, the roller 41 is pressed against the restricting section 91 of the positional restricting member 10 by the spring member 83.

The head feeding section 43 is held in the initial position which is the right movement end in the initial state. At this time, the moving cam 60 is held in the right movement end, and the outbound cam engagement section 60a is engaged with the right end section of the first action section 24a of the cam guide section 24 in the guidance cam 22. A position at which the outbound cam engagement section 60a of the moving cam 60 movable in the front and back direction is engaged with the cam guide section 24 is a first engagement position in a movement range in the front and back direction. A position at which the inbound cam engagement section 60b of the moving cam 60 is engaged with the cam guide section 24 is a second engagement position.

In the initial state, one detecting protrusion section 54b provided in the coupling member 49 of the head feeding section 43 is located to correspond to the position detection sensor 33, and the position detection sensor 33 detects that the head feeding section 43 is present in the initial position.

In the initial state, since the outbound cam engagement section 60a of the moving cam 60 is engaged with the first action section 24a of the cam guide section 24, the head holding lever 46 supported by the cam support lever 45 is located on the upper side in the up and down movement range. Thus, the printing head 65 attached to the head holding lever 46 is located so as to be separated upward from the printing surface 102 of the disc-shaped recording medium 100.

In the initial state mentioned above, when the drive motor 34 is rotated in one direction, the head feeding section 43 is moved to the left side from the initial state toward the folding position, and the outbound operation is initiated.

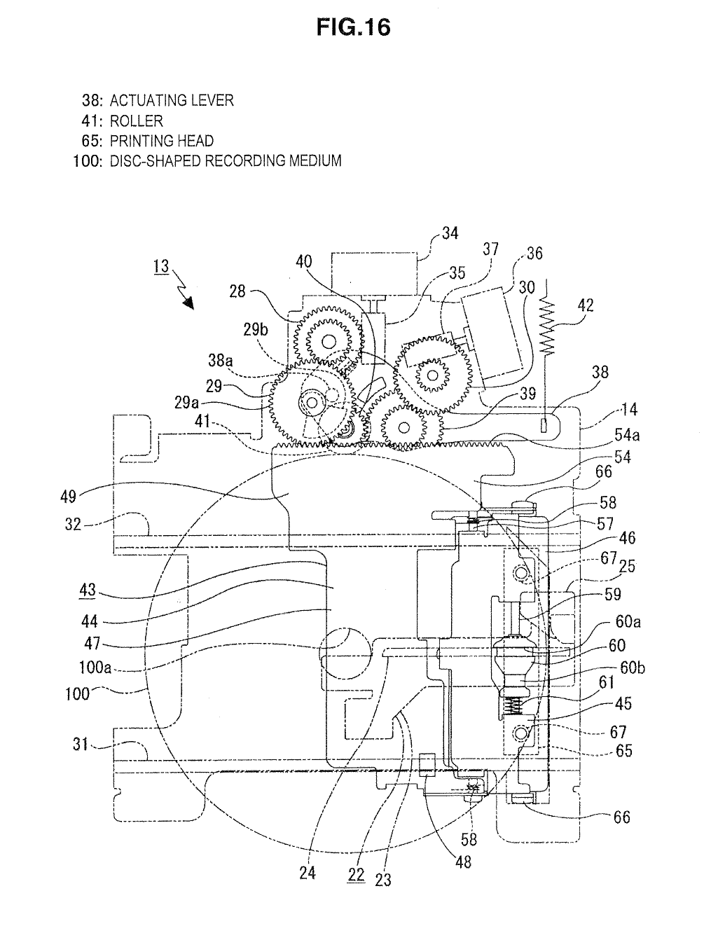

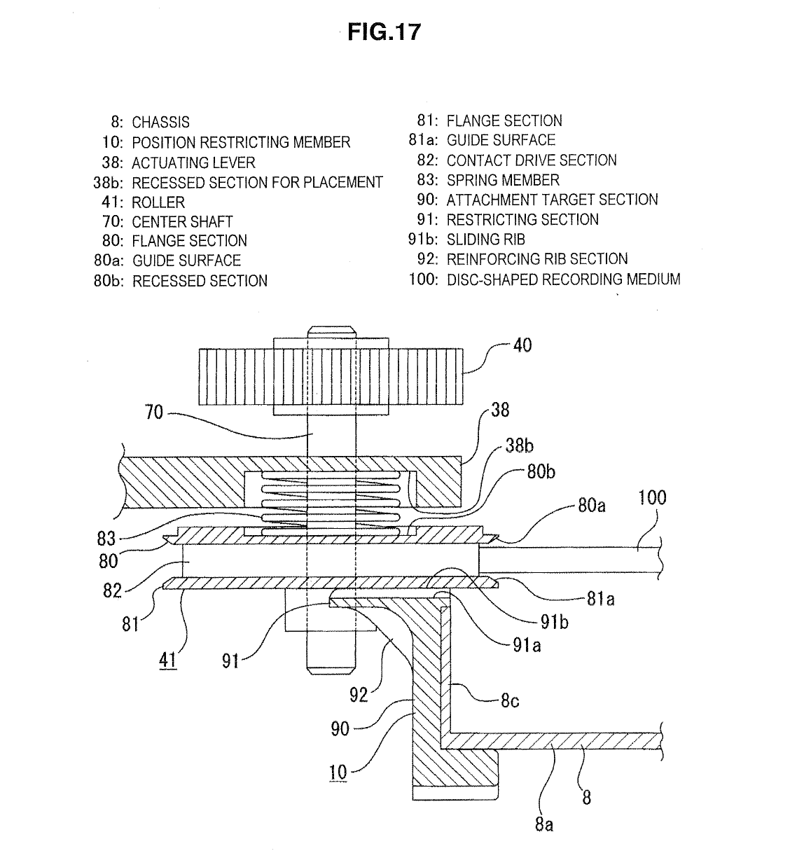

When the drive motor 34 is rotated in one direction, the feeding gear 29 is rotated, and the action section 29b is substantially moved forward. The actuating lever 38 is configured so that the action target protrusion section 38a follows the action section 29b by the biasing force of the tensile coil spring 42, the roller 41 is rotated in a substantially forward moving direction, and the contact drive section 82 of the roller 41 is pressed against the outer circumferential surface of the disc-shaped recording medium 100 and reaches the contact position (see FIGS. 16 and 17). Thus, the rotation of the disc-shaped recording medium 100 is restricted by the roller 41.

At this time, the roller 41 is moved while being pressed against the position restricting member 10 by the spring member 83, and the lower surface of the flange section 81 slides on the sliding rib 91b provided in the restricting section 91 of the restricting member 10.

Thus, since the flange section 81 slides on the sliding rib 91b, the contact area of the roller 41 to the position restricting member 10 is small when the roller 41 is moved, the load to the movement of the roller 41 is small, and the actuating lever 38 and the roller 41 can be smoothly moved (rotated).

Furthermore, as mentioned above, on the surfaces opposite to each other in the outer circumferential sections of the flange sections 80 and 81, guidance surfaces 80a and 81a that separate from each other toward the outer circumferences are formed.

Thus, when the roller 41 approaches the outer circumferential surface of the disc-shaped recording medium 100, the disc-shaped recording medium 100 can be guided by the guidance surfaces 80a and 81a, the disc-shaped recording medium 100 is easily inserted between a pair of flange sections 80 and 81, and it is possible to reliably bring the contact drive section 82 of the roller 41 into contact with the outer circumferential surface of the disc-shaped recording medium 100.

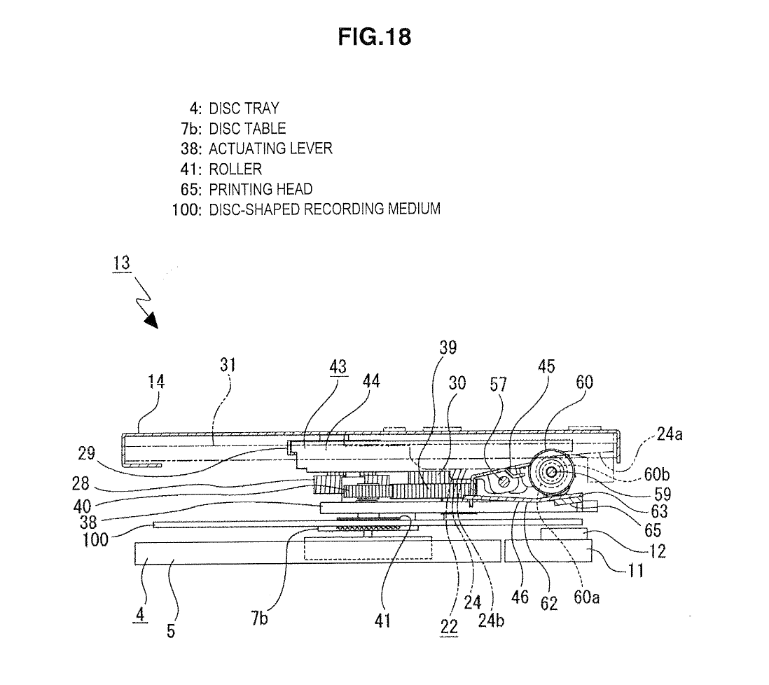

Since the moving cam 60 is biased in the rotational direction in which the cam support lever 45 is moved substantially upward by the rotational biasing springs 58 and 58, the outbound cam engagement section 60a is rotated with respect to the cam engagement section 59 while being pressed against the first action section 24a of the cam guide section 24 and is engaged with the first action section 24a (see FIG. 18). As mentioned above, since the first action section 24a is formed so that an amount of downward protrusion increases toward the second action section 24b, the printing head 65 is gradually moved downward along with the movement to the left side of the head feeding section 43, and approaches the printing surface 102 of the disc-shaped recording medium 100.

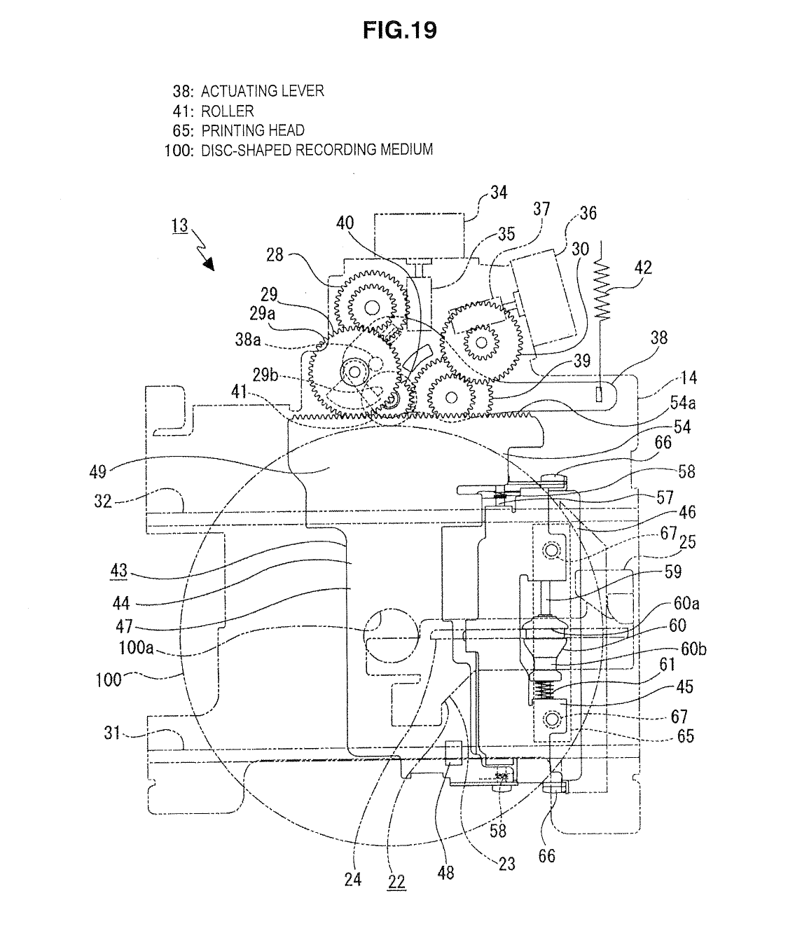

Next, the head feeding section 43 is moved to the left side by the rotation of the drive motor 34, the feeding gear 29 is continuously rotated, and the action section 29b is separated from the action target protrusion section 38a of the actuating lever 38 (see FIG. 19). Thus, the roller 41 is kept in a state in which the contact drive section 82 is pressed against the outer circumferential surface of the disc-shaped recording medium 100, and a state in which the rotation of the disc-shaped recording medium 100 is restricted by the roller 41 is maintained.

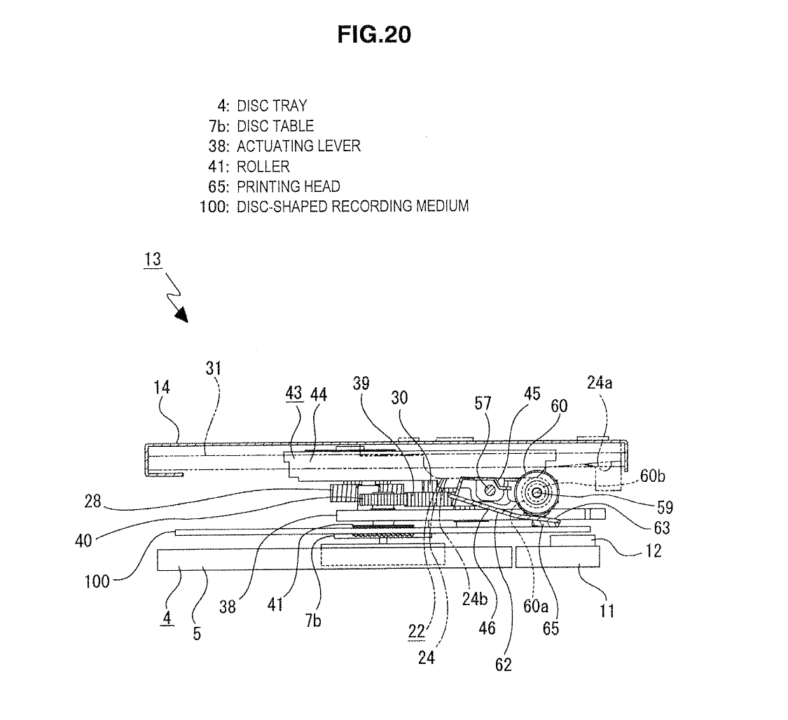

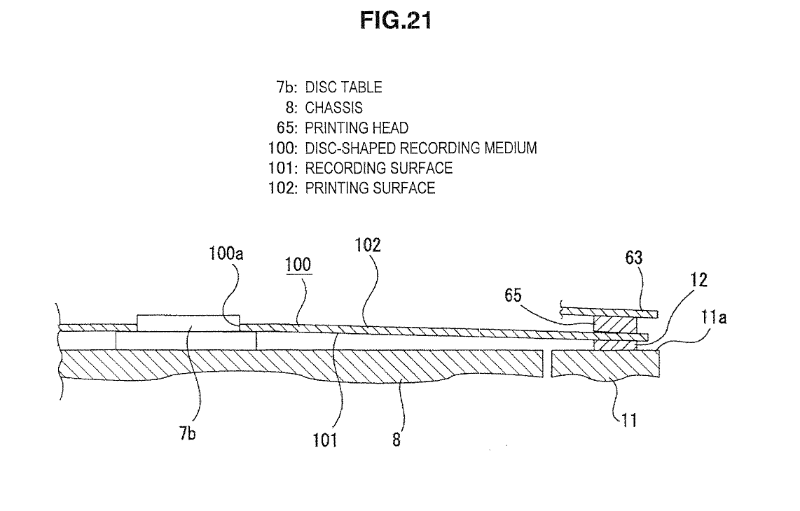

The moving cam 60 is configured so that the outbound cam engagement section 60a is engaged with the right end section of the second action section 24b of the cam guide section 24 (see FIG. 20). Thus, the printing head 65 is moved downward, abuts the outer circumference in the printing surface 102 of the recording medium 100, and the printing on the printing surface 102 using the printing head 65 is initiated. In a state in which the printing head 65 is moved downward, as shown in FIG. 21, the printing head 65 is pressed against the printing surface 102 of the disc-shaped recording medium 100 from the upper side, the disc-shaped recording medium 100 enters a deflected state, and the outer edge of the disc-shaped recording medium 100 is pressed against the cushion member 12 attached to the base surface 11a of the placing base 11.

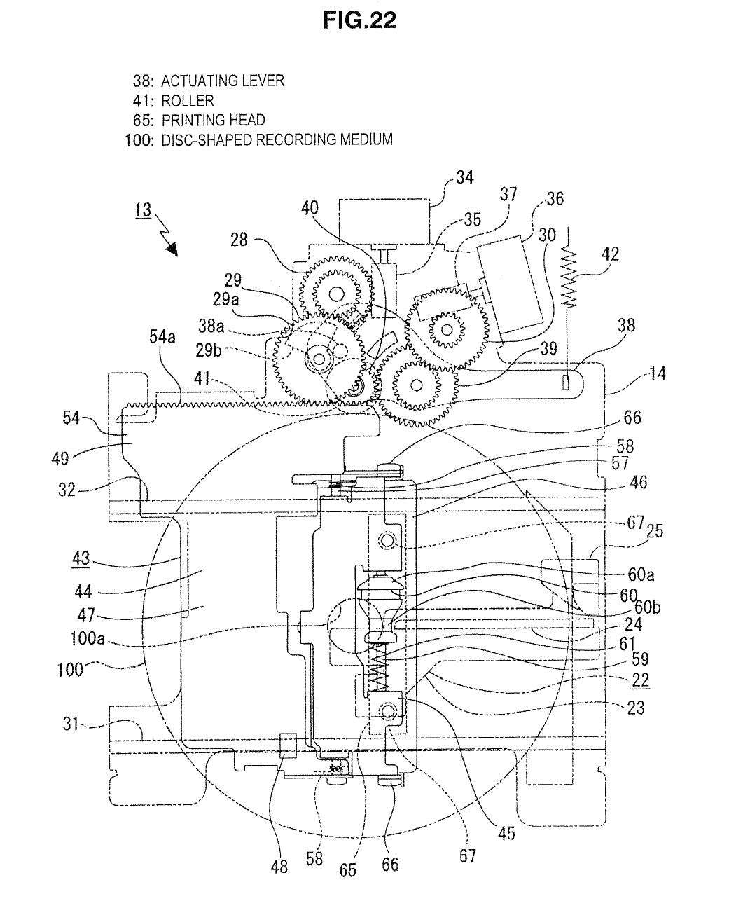

The head feeding section 43 is continuously moved to the left side by the rotation of the drive motor 34 and is moved up to the folding position (see FIG. 22). When the head feeding section 43 is moved up to the movement end of the left side, one detecting protrusion section 54b provided in the coupling member 49 of the head feeding section 43 is located to correspond to the position detection sensor 33, the movement of the head feeding section 43 to the folding position is detected by the position detection sensor 33, and the rotation of the drive motor 34 is stopped temporarily.

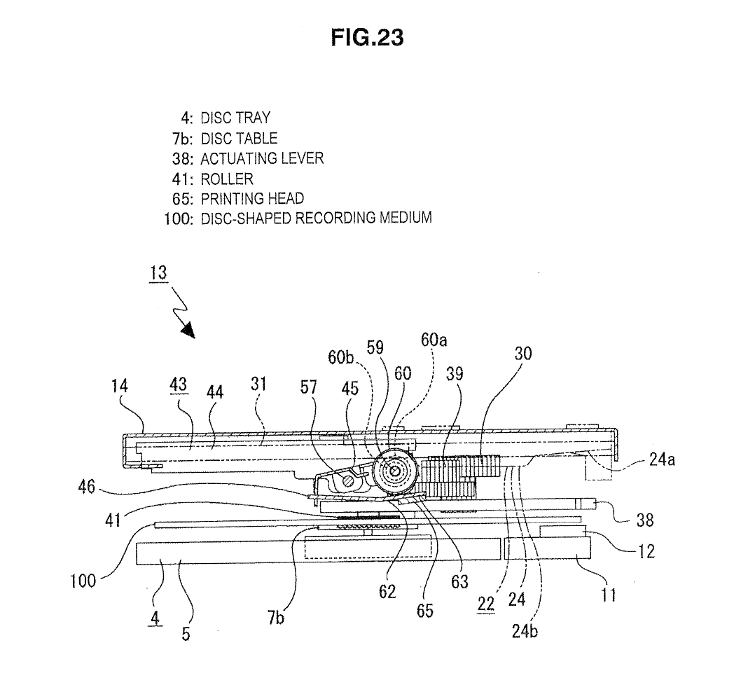

When the head feeding section 43 is moved up to the folding position, the moving cam 60 is rotated in a state in which the outbound cam engagement section 60a is pressed against the second action section 24b of the cam guide section 24. The moving cam 60 is moved to the left movement end along with the movement of the head feeding section 43 to the folding position (see FIG. 23). At this time, the printing head 65 comes into slide-contact with the printing surface 102 of the disc-shaped recording medium 100 to perform the printing on the printing surface 102 using the printing head 65.

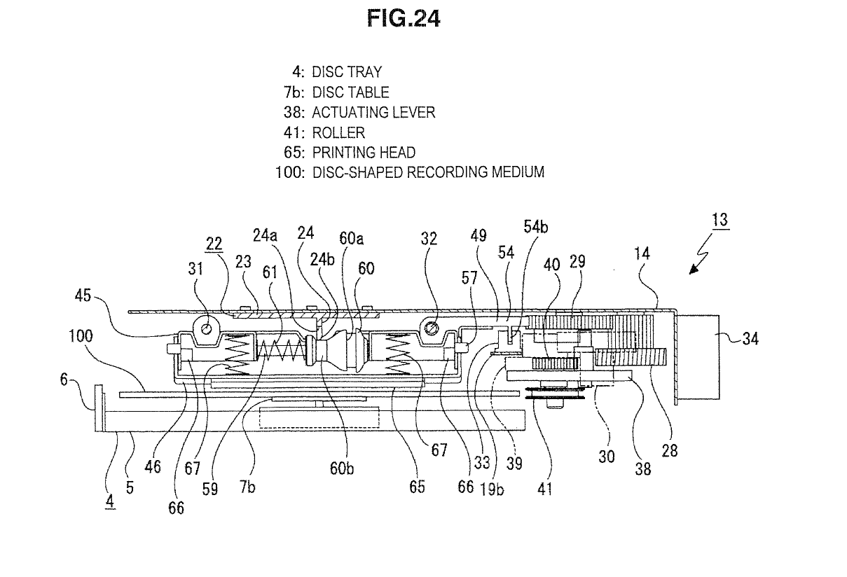

When the head feeding section 434 is moved to the folding position, the outbound cam engagement section 60a of the moving cam 60 is moved from the second action section 24b of the cam guide section 24 to the left side, and the engagement with the cam guide section 24 is released (see FIG. 22). Thus, the moving cam 60 is moved backward by the biasing force of the biasing spring 61 and is maintained in a second engagement position, and the inbound cam engagement section 60b is located on the left side of the second action section 24b of the cam guide section 24 (see FIGS. 22 and 24).

When the head feeding section 43 is moved to the folding position, since the engagement of the moving cam 60 to the cam guide section 24 is released, the cam support lever 45 and the head holding lever 46 are moved substantially upward by the biasing force of the rotational biasing springs 58 and 58, the printing head 65 is located so as to be separated upward from the printing surface 102 of the disc-shaped recording medium 100, and the printing on the printing surface 102 using the printing head 65 is finished.

As mentioned above, when the position detection sensor 33 detects the movement of the head feeding section 43 to the folding position, the drive motor 34 is reversely rotated to rotate in the other direction.

The head feeding section 43 is moved to the right side from the folding position toward the initial position by the rotation of the drive motor 34 to the other direction, and the inbound operation is initiated. In the inbound path, the non-printing operation, in which the printing surface 102 of the disc-shaped recording medium 100 is not printed using the printing head 65, is performed.

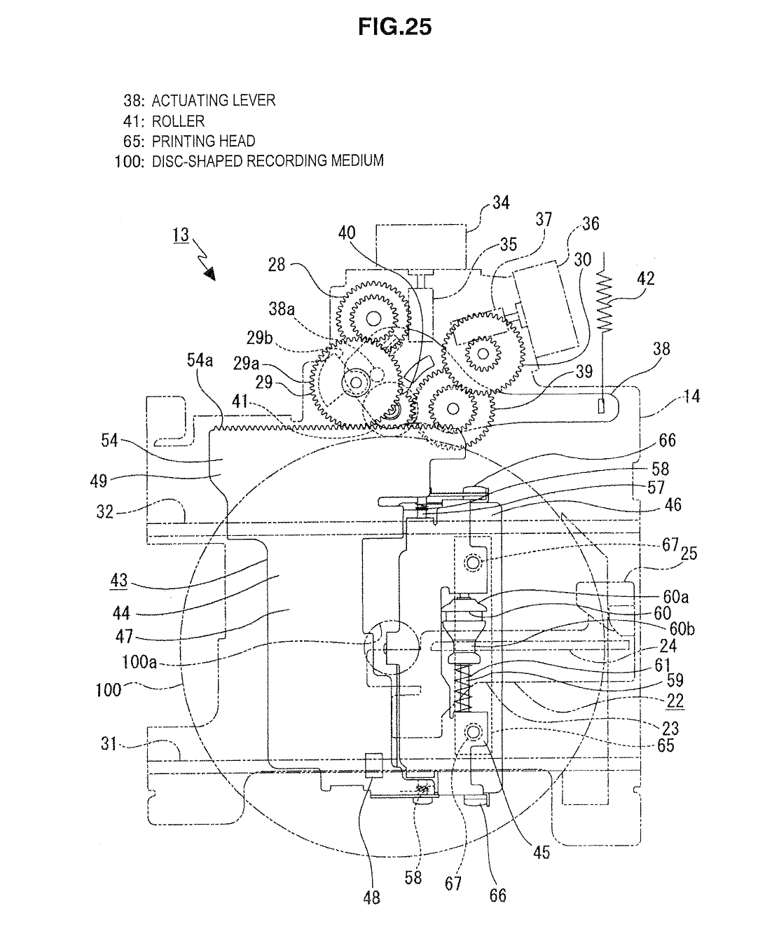

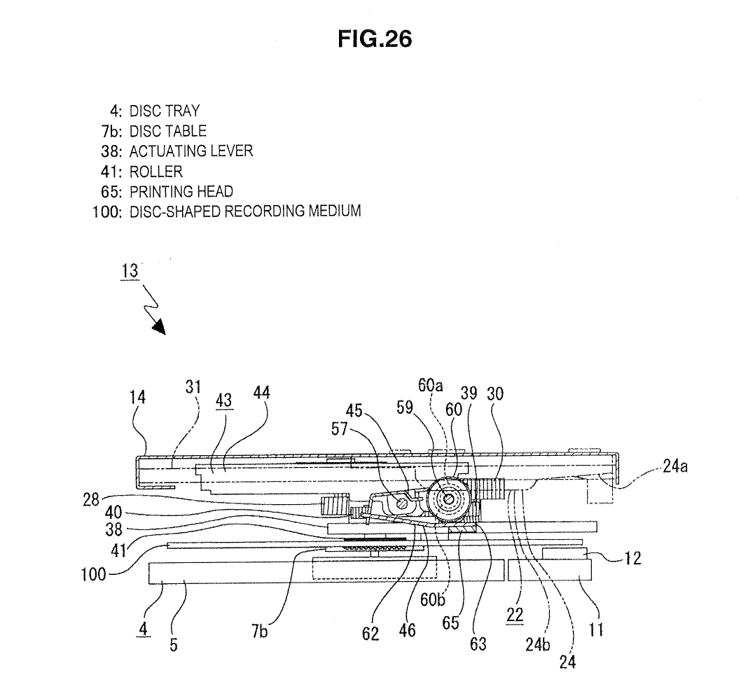

When the head feeding section 43 is moved from the folding position to the right side, the moving cam 60 is rotated in a state in which the inbound cam engagement section 60b is pressed against the second action section 24b of the cam guide section 24 (see FIGS. 25 and 26). At this time, the printing head 65 is moved to the right side while being held in a position separated upward between the guide shafts 31 and 32 and the printing surface 102.

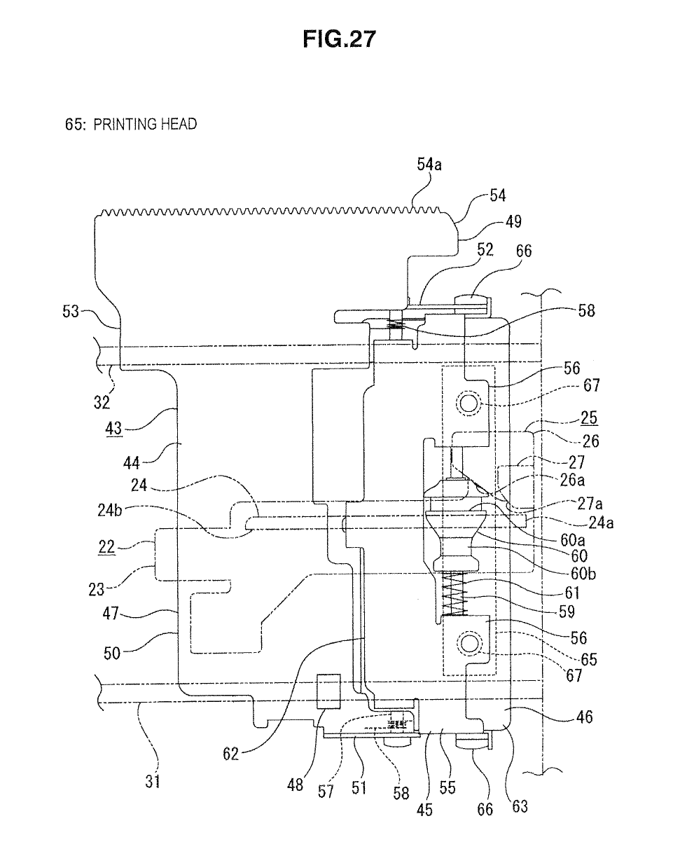

When the head feeding section 43 is moved to the right side and the inbound cam engagement section 60b of the moving cam 60 is engaged over the first action section 24a from the second action section 24b of the cam guide section 24, the rear end section of the moving cam 60 continuously slides on the guidance surface 26a and the guidance surface 27a of the return cam 25 (see FIG. 27). Thus, the moving cam 60 is moved forward against the biasing force of the biasing spring 61 as it is moved to the right side.

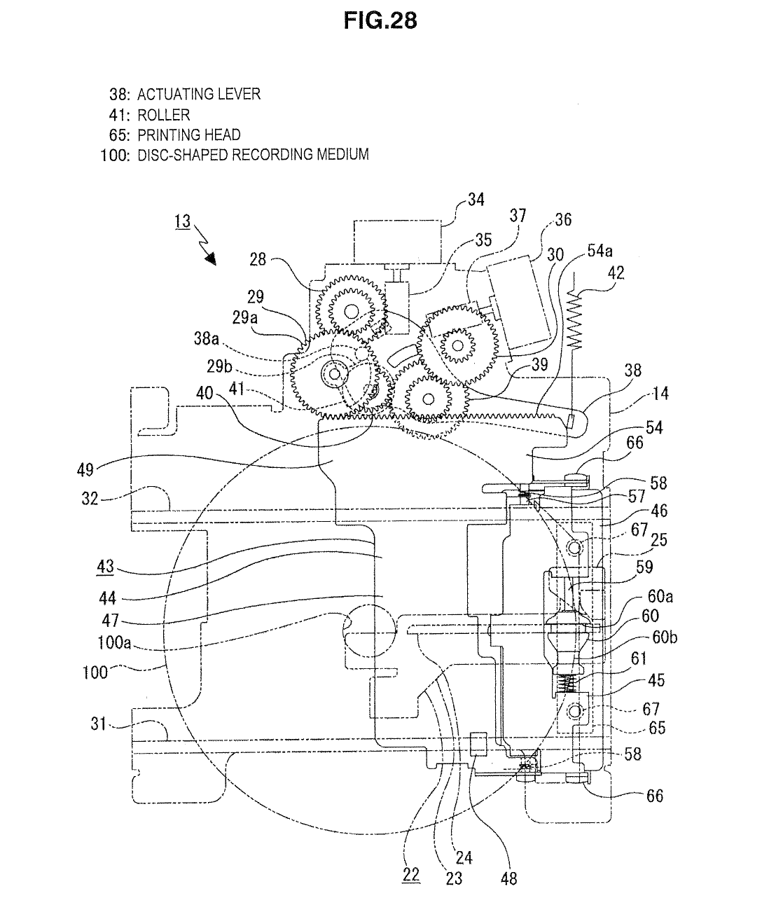

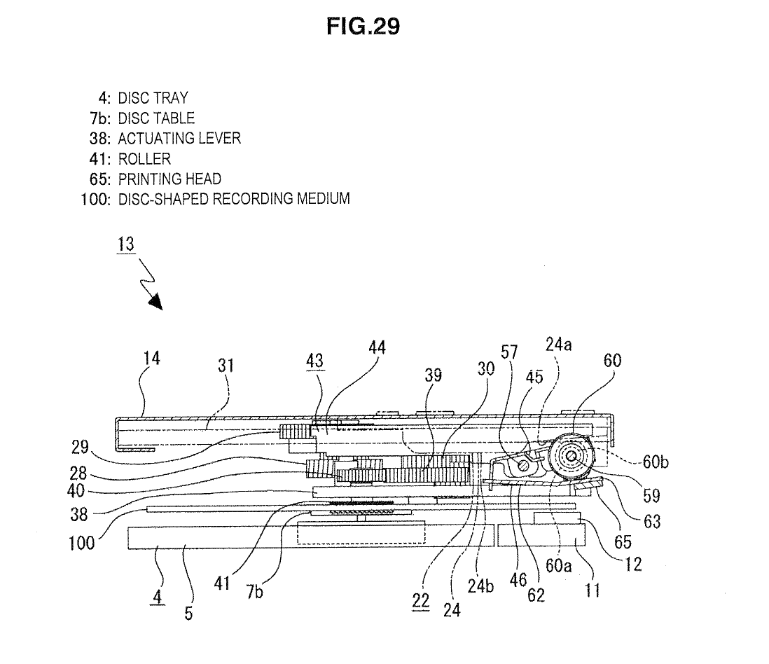

The head feeding section 43 is continuously moved to the right side by the rotation of the drive motor 34 and reaches the initial position (see FIGS. 28 and 29). When the head feeding section 43 is moved to the initial position, the printing head 65 is held in the movement end of the right side. Furthermore, immediately before the head feeding section 43 is moved to the initial position, the moving cam 60 slides on the return cam 25 as the moving cam 60 is moved to the right side, and is moved forward. Thus, when the head feeding section 43 is moved to the initial position, the outbound cam engagement section 60a is engaged with the first action section 24a of the cam guide section 24 and reaches the first engagement position.

When the head feeding section 43 is moved to the movement end of the right side, one detecting protrusion section 54b provided in the coupling member 49 is located to correspond to the position detection sensor 33, and the detection sensor 33 detects that the head feeding section 43 is present in the initial position. Thus, the rotation of the drive motor 34 is stopped once. At this time, the action section 29b is engaged with the action target protrusion section 38a of the actuating lever 38 by the feeding gear 29 from the front, and the action target protrusion section 38a is pressed backward. Thus, the actuating lever 38 is rotated against the biasing force of the tensile coil spring 42, the roller 41 is separated backward from the outer circumferential surface of the disc-shaped recording medium 100 and is moved to the non-contact position, and thus the restriction of the rotation of the disc-shaped recording medium 100 is released.

As mentioned above, the head feeding section 43 returns to the initial position, the printing head 65 returns to the first position, the moving cam 60 returns to the first engagement position, the actuating lever 38 is rotated, and the roller 41 is separated from the outer circumferential surface of the disc-shaped recording medium 100, returns to the non-contact position, and thus returns to the initial state.

In the printing operation mentioned above, the reciprocating operation of a distance corresponding to the size of a radius of the disc-shaped recording medium 100 using the head feeding section 43 is performed, and the printing is performed within a region of about ¼ of the printing surface 102 of the disc-shaped recording medium 100.

Thus, when performing the printing within another region of about ¼ of the printing surface 102 of the disc-shaped recording medium 100, the operation to be described below is performed.

In the initial state mentioned above, the drive motor 34 is rotated in one direction again, and the head feeding section 43 is moved to the left side from the initial position toward the folding position.

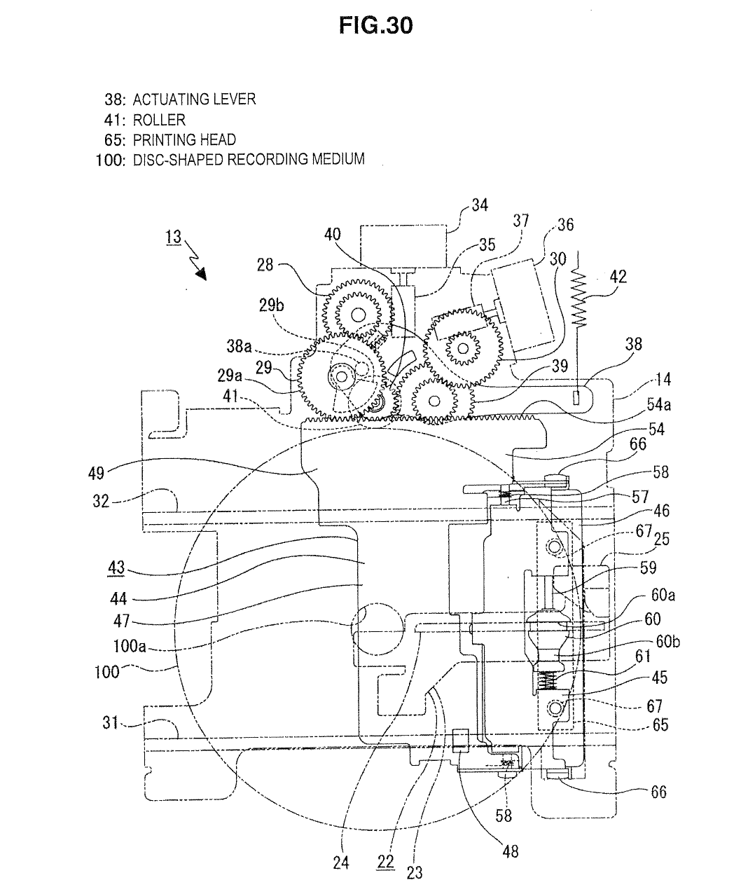

When the drive motor 34 is rotated in one direction, the feeding gear 29 is rotated, and the action section 29b is moved substantially forward. The actuating lever 38 is configured so that the action target protrusion section 38a follows the action section 29b by the biasing force of the tensile coil spring 42, the roller 41 is rotated in a direction moved substantially forward, and the contact drive section 82 of the roller 41 is pressed against the outer circumferential surface of the disc-shaped recording medium 100 (see FIG. 30).

When the contact drive section 82 of the roller 41 is pressed against the outer circumferential surface of the disc-shaped recording medium 100, the rotation of the drive motor 34 in one direction is stopped once.

The moving cam 60 is moved along with the movement of the head feeding section 43 to the left side, and the outbound cam engagement section 60a is rotated while being pressed against the first action section 24a of the cam guide section 24, and is engaged with the left end section of the first action section 24a.

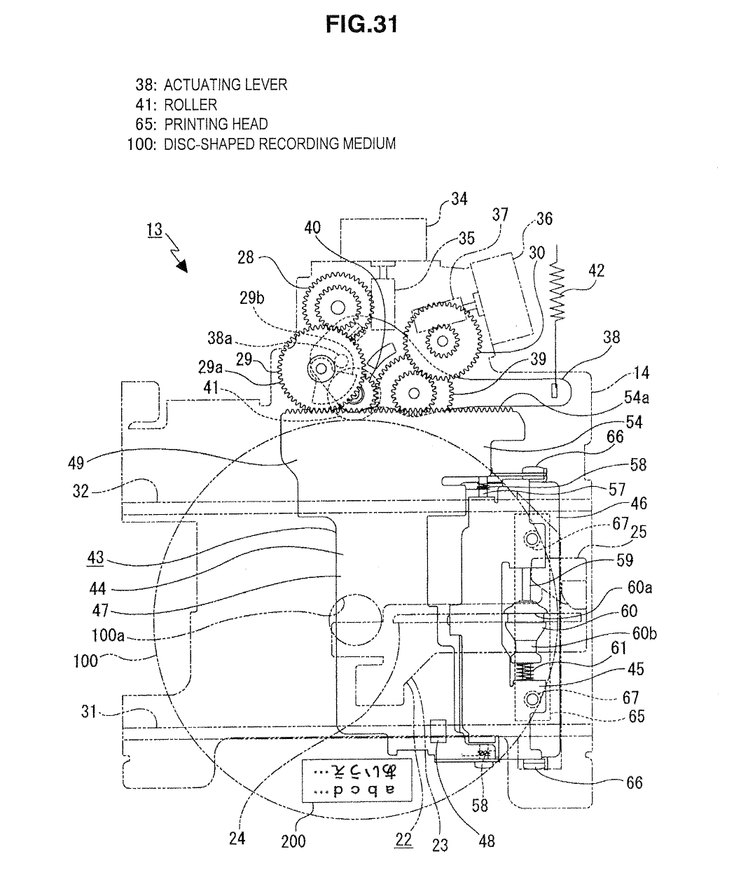

At this time, the rotating motor 36 is rotated, and the roller 41 is rotated. The disc-shaped recording medium 100 held in the disc table 7b is rotated by the rotation of the roller 41 (see FIG. 31). When the disc-shaped recording medium 100 is rotated by, for example, 90°, the rotation of the rotating motor 36 is stopped, and the rotation of the disc-shaped recording medium 100 is restricted by the roller 41 again.

When the rotation of the rotating motor 36 is stopped, the rotation of the drive motor 34 in one direction is resumed, and the head feeding section 43 is moved to the left side toward the folding position again. Thus, the printing operation is performed before being rotated by 90°, and the printing operation of the printing surface 102 of the disc-shaped recording medium 100 is performed using the printing head 65 as mentioned above in a region different from the region formed with the printing 200.

### [Summary]

As mentioned above, in the disc drive device 1, the roller 41 is axially biased by the spring member 83 and is pressed against the position restricting member 10 to perform the positioning of the roller 41 in the axial direction.

Thus, the positional accuracy of the roller 41 in the axial direction is enhanced, the roller 41 reliably comes into contact with the correct position of the outer circumferential surface of the disc-shaped recording medium 100, the contact defect of the roller 41 to the disc-shaped recording medium 100 is not generated, and it is possible to prevent the occurrence of the problem due to the contact defect of the roller 41 to the disc-shaped recording medium 100.

Thus, the position restricting member 10 is attached to the chassis 8 by which the disc tray 4 supporting the disc table 7b with the disc-shaped recording medium 100 mounted thereon is movably supported.

Thus, the positional accuracy of the position restricting member 10 to the disc-shaped recording medium 100 is high, and it is therefore possible to secure satisfactory positional accuracy of the roller 41 and the disc-shaped recording medium 100 pressed against the position restricting member 10.

### [The Present Technology]

Additionally, the present technology may also be configured as below.

(1) A disc drive device comprising:

a recording and playback unit that performs recording or playback of an information signal on a disc-shaped recording medium having a printing surface and a recording surface;

a printing head that performs printing on the printing surface of the disc-shaped recording medium;

a roller that is separated from or comes into contact with an outer circumferential surface of the disc-shaped recording medium and rotates the disc-shaped recording medium by being rotated while in contact with the outer circumferential surface;

a spring member that biases the roller in an axial direction of the roller; and

a position restricting member that has a restricting section against which the roller biased by the spring member is pressed and performs the positioning of the roller in the axial direction.

(2) The disc drive device according to (1),

wherein the roller is rotated in a state in which one surface thereof in the axial direction is pressed against the restricting section, and

the restricting section of the position restricting member is provided with a sliding rib which protrudes to the one surface side of the roller and along which the one surface slides.

(3) The disc drive device according to (1) or (2),

wherein the recording and playback unit has a disc table on which the disc-shaped recording medium is mounted,

the recording and playback unit is supported by a disc tray that is moved in a predetermined direction,

a chassis, on which the disc tray is movably supported, is provided, and

the position restricting member is attached to the chassis.

(4) The disc drive device according to any one of (1) to (3),

wherein the position restricting member is provided with an attachment target section attached to the chassis, and a reinforcing rib section that connects the attachment target section with the restricting section.

(5) The disc drive device according to any one of (1) to (4),

wherein an actuating lever, on which the roller is rotatably supported and which is moved in a direction to be separated from or come into contact with the outer circumferential surface of the disc-shaped recording medium, is provided,

the spring member is placed between the actuating lever and the roller,

the actuating lever is formed with a recessed section for placement opened to the roller side, and

at least a part of the spring member is placed in the recessed section for placement.

(6) The disc drive device according to (5),

wherein the roller is formed with a recessed section opened to the actuating lever side, and

at least a part of the spring member is placed in the recessed section.

(7) The disc drive device according to any one of (1) to (6),

wherein a coil spring is used as the spring member, and

a center axis serving as a rotation center of the roller is located inside the spring member.

(8) The disc drive device according to any one of (1) to (7),

wherein the roller is provided with a pair of flange sections located so as to be separated from each other in the axial direction, and a contact drive section which is located between the pair of flange sections, is in contact with the outer circumferential surface of the disc-shaped recording medium and has an outer diameter smaller than those of the flange sections, and

the surfaces opposite to each other on outer circumferential sections of the pair of flange sections are formed with guidance surfaces which separate from each other toward an outer circumference.

The specific shapes and the structures of the respective sections shown in the preferred embodiment mentioned above merely show an example of the embodiment when implementing the present technology, and the technical scope of the present technology should not be interpreted in a limited manner by these. It should be understood by those skilled in the art that various modifications, combinations, sub-combinations and alterations may occur depending on design requirements and other factors insofar as they are within the scope of the appended claims or the equivalents thereof.

The present technology contains subject matter related to that disclosed in Japanese Priority Patent Application JP 2011-187928 filed in the Japan Patent Office on Aug. 30, 2011, the entire content of which is hereby incorporated by reference.

What is claimed is:

1. A disc drive device comprising:
a recording and playback unit that performs recording or playback of an information signal on a disc-shaped recording medium having a printing surface and a recording surface;
a printing head that performs printing on the printing surface of the disc-shaped recording medium;
a roller that is separated from or comes into contact with an outer circumferential surface of the disc-shaped recording medium and rotates the disc-shaped recording medium by being rotated while in contact with the outer circumferential surface;
a spring member that biases the roller in an axial direction of the roller; and
a position restricting member that has a restricting section against which the roller biased by the spring member is pressed and performs the positioning of the roller in the axial direction.

2. The disc drive device according to claim 1,
wherein the roller is rotated in a state in which one surface thereof in the axial direction is pressed against the restricting section, and
the restricting section of the position restricting member is provided with a sliding rib which protrudes to the one surface side of the roller and along which the one surface slides.

3. The disc drive device according to claim 1,
wherein the recording and playback unit has a disc table on which the disc-shaped recording medium is mounted,
the recording and playback unit is supported by a disc tray that is moved in a predetermined direction,
a chassis, on which the disc tray is movably supported, is provided, and
the position restricting member is attached to the chassis.

4. The disc drive device according to claim 1,
wherein the position restricting member is provided with an attachment target section attached to the chassis, and a reinforcing rib section that connects the attachment target section with the restricting section.

5. The disc drive device according to claim 1,
wherein an actuating lever, on which the roller is rotatably supported and which is moved in a direction to be separated from or come into contact with the outer circumferential surface of the disc-shaped recording medium, is provided,
the spring member is placed between the actuating lever and the roller,
the actuating lever is formed with a recessed section for placement opened to the roller side, and
at least a part of the spring member is placed in the recessed section for placement.

6. The disc drive device according to claim 5,
wherein the roller is formed with a recessed section opened to the actuating lever side, and
at least a part of the spring member is placed in the recessed section.

7. The disc drive device according to claim 1,
wherein a coil spring is used as the spring member, and
a center axis serving as a rotation center of the roller is located inside the spring member.

8. The disc drive device according to claim 1,
wherein the roller is provided with a pair of flange sections located so as to be separated from each other in the axial direction, and a contact drive section which is located between the pair of flange sections, is in contact with the outer circumferential surface of the disc-shaped recording medium and has an outer diameter smaller than those of the flange sections, and
the surfaces opposite to each other on outer circumferential sections of the pair of flange sections are formed with guidance surfaces which separate from each other toward an outer circumference.
